(19) United States
(12) Patent Application Publication
(10) Pub. No.: US 2015/0191621 A1
(43) Pub. Date: Jul. 9, 2015

(54) LAMINATED POLYESTER FILM

(71) Applicant: TORAY INDUSTRIES, INC., Tokyo (JP)

(72) Inventors: Yu Abe, Otsu-shi (JP); Masami Ogata, Otsu-shi (JP); Yasushi Takada, Otsu-shi (JP)

(73) Assignee: TORAY INDUSTRIES, INC., Tokyo (JP)

(21) Appl. No.: 14/408,897

(22) PCT Filed: Jun. 19, 2013
(86) PCT No.: PCT/JP2013/066794

§ 371 Date: Dec. 17, 2014

(30) Foreign Application Priority Data
Aug. 10, 2012 (JP) 2012-178083

(51) Int. Cl. C09D 133/26

(52) U.S. Cl. CPC C09D 133/26

(57) ABSTRACT

The purpose of the present invention is to provide a laminated polyester film which has excellent translucency and excellent suppression of an iris-like pattern (interference fringe), i.e., excellent visibility, when a hard coat layer is laminated; has excellent initial adhesion to the hard coat layer, adhesiveness at high temperatures and high humidity (wet heat-resistant adhesion), and UV-resistant adhesion (adhesion after UV irradiation); and has excellent adhesion when immersed in boiling water (boiling-resistant adhesion) and boiling-resistant translucency. This objective is achieved by a laminated polyester film having a resin layer (X) on at least one surface of a polyester film, wherein the resin layer (X) is formed from a coating composition comprising an acrylic/urethane copolymer resin (a) and a polyester resin (b) having a naphthalene backbone, and the film haze change amount (ΔHz) before and after a boiling treatment test (ΔHz=the film haze after the boiling treatment test−the film haze before the boiling treatment test) is less than 3.0%.

### TECHNICAL FIELD

The present invention relates to a laminated polyester film including a polyester film and a resin layer provided on at least one side thereof. More specifically, the present invention aims to provide a laminated polyester film that is high in transparency and ability to depress the iris-like pattern (interference pattern) likely to occur after lamination with a hard coat layer (to maintain visibility), high in initial adhesiveness to a hard coat layer, wet-heat-resistant adhesiveness, and adhesiveness after ultraviolet ray (UV) irradiation (UV-resistant adhesiveness), high in adhesiveness after immersion in boiling water (boiling-resistant adhesiveness), and high in ability to depress the deterioration in transparency (transparency reduction) when immersed in boiling water (boiling-resistant transparency).

### BACKGROUND ART

Generally known display devices include touch-sensitive panels that are used in the screens of image display equipment to send predetermined information to a data processing apparatus when a particular position on a screen is touched. In many image displaying apparatuses including those image displaying apparatuses provided with touch-sensitive panels, a hard coat film is provided on their outermost surface to prevent flaws. In recent years, increased numbers of image displaying apparatuses such as portable telephones, laptop PCs, and personal portable information devices (personal digital assistants, PDAs) are used outdoors. Hard coat films contained in image display apparatuses for outdoor uses, such as car navigation systems, are required to be resistant to peeling between the hard coat layer and base film as they are exposed to ultraviolet ray for a long period of time (UV-resistant adhesiveness).

Furthermore, high adhesiveness in high temperature, high humidity environments is required for hard coat films used in portable apparatuses such as portable telephones, particularly those portable telephones provided with touch-sensitive panels. As many portable apparatuses in recent years are designed for use in bathrooms, increased adhesiveness in a wet-heat-resistant environment (wet-heat-resistant adhesiveness) is sought after strongly. Hard coat films designed for such uses have to be so high in wet-heat-resistant adhesiveness that adhesion is maintained after the films are left for 250 to 500 hours in a 85° C., 85% RH environment. Some films in recent years are required to have boiling-resistant adhesiveness to maintain adhesiveness under harsher conditions such as immersion in boiling water (100° C.) and boiling-resistant adhesiveness to maintain transparency after immersion in boiling water (100° C.) (depress the reduction in transparency). Thus, there are stronger calls for laminated polyester films that can meet those requirements for adhesiveness and transparency under harsh conditions and effectively depress the iris-like pattern (interference pattern) likely to occur after lamination with a hard coat layer (to maintain visibility).

Accordingly, studies have been conducted to develop techniques to impart adhesiveness to polyester film surfaces using various methods. Proposals made so far include, for example, a method in which a primer layer of acrylic modified polyurethane is formed on the film surface (Patent document 1), a method in which copolymerized polyester resin and an isocyanate based crosslinking agent are used to form a primer layer (Patent document 2), a method in which polyurethane resin and a carbodiimide based crosslinking agent are used to form a primer layer (Patent document 3), a method in which a primer layer containing an acrylic-urethane copolymer resin, isocyanate based compound, oxazoline based compound, and carbodiimide based compound is formed (Patent document 4), and 30 to 70% of a melamine compound, compound having a naphthalene ring, and urethane resin are used to form a primer layer (Patent document 5).

### PRIOR ART DOCUMENTS

### Patent Documents

Patent document 1: Japanese Unexamined Patent Publication (Kokai) No. 2000-229394
Patent document 2: Japanese Unexamined Patent Publication (Kokai) No. 2003-49135
Patent document 3: Japanese Unexamined Patent Publication (Kokai) No. 2001-79994
Patent document 4: International Publication WO 2007/032295
Patent document 5: Japanese Patent No. 4916339

### SUMMARY OF THE INVENTION

### Problems to be Solved by the Invention

In Patent document 1, initial adhesiveness with ultraviolet curable ink is high, but there may occur problems such as inability to develop adhesiveness under wet-heat-resistant conditions and boiling-resistant adhesiveness.

The method described in Patent document 2 can be effective in improving the wet-heat-resistant adhesiveness to some extent, but cannot achieve sufficient adhesiveness to UV curable resin, particularly with solvent-free UV curable resin used to produce a prism lens layer.

The methods described in Patent document 3 and Patent document 4 have the problem of insufficient visibility (interference pattern) due to a low refractive index of the resin itself, in spite of increased wet-heat-resistant adhesiveness in addition to high initial adhesiveness.

The method described in Patent document 5, furthermore, has the problem of insufficient wet-heat-resistant adhesiveness and boiling-resistant adhesiveness, although a compound with a naphthalene ring serves to prevent a decrease in the refractive index to improve visibility and initial adhesiveness. In addition, the method described in Patent document 5 contains a large quantity of a melamine compound, causing problems such as process contamination due to volatilization of the melamine compound in production steps and generation of formaldehyde, which is harmful to human beings, from crosslinking reaction of the melamine compound.

As described above, it is impossible for the conventional techniques to meet all the requirements for depression of interference patterns (visibility), UV-resistant adhesiveness, and wet-heat-resistant adhesiveness. Furthermore, the conventional techniques cannot meet the requirements for boiling-resistant adhesiveness and boiling-resistant transparency.

Thus, an object of the present invention is to solve the above problems to provide a laminated polyester film that is high not only in initial adhesiveness but also in wet-heat-resistant adhesiveness and adhesiveness after UV irradiation in particular, and also high in boiling-resistant adhesiveness and boiling-resistant transparency. The invention also aims to provide a laminated polyester film having good characteristics as described above even when it contains none or only a slight amount of a melamine compound.

### Means of Solving the Problems

The laminated polyester film according to the present invention has the following constitution.

(1) A laminated polyester film including a polyester film and a resin layer (X) provided on at least one side thereof, the resin layer (X) being a layer formed of a coating composition containing acrylic-urethane copolymer resin (a) and polyester resin with a naphthalene skeleton (b), and the film undergoing a change in the film haze, ΔHz, of less than 3.0% during boiling treatment test (ΔHz=film haze before and after boiling test−film haze before boiling test).
(2) A laminated polyester film including a polyester film and a resin layer (X) provided on at least one side thereof, the resin layer (X) being a layer formed of a coating composition containing acrylic-urethane copolymer resin (a), polyester resin with a naphthalene skeleton (b), an isocyanate compound (c), a carbodiimide compound (d), and an oxazoline compound (e), and the aggregate that contains the acrylic-urethane copolymer resin (a) in the layer (X) having a dispersion index of 5 or less.
(3) A laminated polyester film as described in either paragraph (1) or (2), wherein the minimum value of the spectral reflectance of the resin layer (X) in the wavelength range of 450 nm or more and 650 nm or less is 4.5% or more and 6.0% or less.
(4) A laminated polyester film as described in any one of paragraphs (1) to (3), wherein the polyester resin (b) is copolymer polyester resin in which the aromatic dicarboxylic acid components containing a metal sulfonate group accounts for 1 to 30 mol % of the total quantity of the dicarboxylic acid components.
(5) A laminated polyester film as described in any one of paragraphs (1) to (4), wherein the polyester resin (b) contains a diol component as expressed by Formula (1) given below.

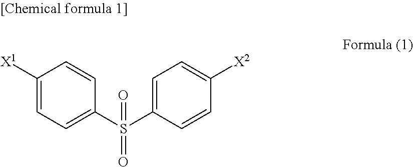

Here, X¹ and X² are —(CₙH₂ₙO)ₘ—H; n is an integer of 2 or more and 4 or less; and m is an integer of 1 or more and 15 or less.

(6) A laminated polyester film as described in any one of paragraphs (1) to (5), wherein the ratio by weight between the solid content of the acrylic-urethane copolymer resin (a) and the solid content of the polyester resin (b) in the coating composition is 40/60 to 5/95.
(7) A laminated polyester film as described in any one of paragraphs (1) to (6) that is produced by applying the coating composition in which the solid content by weight of the isocyanate compound (c), the solid content by weight of the carbodiimide compound (d), and the solid content by weight of the oxazoline compound are 3 to 20 parts by weight, 10 to 40 parts by weight, and 10 to 40 parts by weight, respectively, relative to the total solid content by weight, which accounts for 100 parts by weight, of the acrylic-urethane copolymer resin (a) and the polyester resin (b).
(8) A laminated polyester film as described in paragraph (7), wherein the coating composition contains 5 to 30 parts by weight of a melamine compound (f) in terms of solid content by weight.

### Advantageous Effect of the Invention

The laminated polyester film according to the present invention is high in transparency and ability to depress the iris-like pattern (interference pattern) likely to occur after lamination with a hard coat layer (to maintain visibility), high in initial adhesiveness to a hard coat layer, and also high in wet-heat-resistant adhesiveness, UV-resistant adhesiveness, boiling-resistant adhesiveness, and high in ability to depress the deterioration in transparency (transparency reduction) when immersed in boiling water (boiling-resistant transparency).

### BRIEF DESCRIPTION OF THE DRAWINGS

FIG. 1 schematically shows a cross section of a laminated polyester film with a dispersion index of 5 or more.

FIG. 2 schematically shows a cross section of a laminated polyester film with a small dispersion index.

FIG. 3 schematically shows a cross section of a laminated polyester film with a small dispersion index.

FIG. 4 schematically shows a plane for cross-sectional observation of a laminated polyester film.

### DESCRIPTION OF PREFERRED EMBODIMENTS

The laminated polyester film according to the present invention is described in more detail below.

The laminated polyester film according to the present invention has a polyester film that works as base and a resin layer (X) is provided on at least one side of the polyester film.

For the present invention, the polyester that constitutes the polyester film used as base collectively means those polymers in which the major bonds in the backbone chain are ester bonds. Preferable polyester polymers include those composed mainly of at least one constituent resin selected from the group consisting of ethylene terephthalate, ethylene-2,6-naphthalate, butylene terephthalate, propylene terephthalate, 1,4-cyclohexane dimethylene terephthalate, and the like. These constituent resins may be used singly or two or more thereof may be used in combination. To implement the present invention, the limiting viscosity (measured in o-chlorophenol at 25° C.) of the aforementioned polyesters is preferably in the range of 0.4 to 1.2 dl/g, more preferably 0.5 to 0.8 dl/g.

Here, these polyesters may also contain various additives including, for instance, antioxidant, thermal stabilizer, weathering stabilizer, ultraviolet absorber, organic lubricant, pigment, dye, organic or inorganic fine particles, filler, antistatic agent, nucleating agent, and crosslinking agent unless they deteriorate the characteristics of the polyesters.

As the above polyester film, it is preferable to use a biaxially orientated polyester film. A biaxially orientated film as referred to herein is defined as one that shows a biaxially orientated pattern in wide angle X-ray diffraction observation. In general, a biaxially orientated polyester film can be produced by stretching an unstretched polyester sheet by 2.5 to 5.0 times both in the sheet length direction and in the width direction and subsequently heat-treating it.

The polyester film used as base may be a laminated structure containing two or more layers. Such a laminated structure may be, for example, a composite film composed of an inner layer part and a surface layer part in which the inner layer part is substantially free of particles while only the surface layer part contains particles. Here, the polyester component constituting the inner layer part and that constituting the surface layer part may be identical to or different from each other.

There are no specific limitations on the thickness of the polyester film and an appropriate thickness may be adopted according to the uses and type of the film. From the viewpoint of mechanical strength, handleability, etc., however, commonly it is preferably 10 to 500 μm, more preferably 38 to 250 μm, and most preferably 75 to 150 μm. Furthermore, the polyester film may be a composite film produced by co-extrusion or one produced by combining separate films by any of various methods.

The laminated polyester film according to the present invention is a laminated polyester film including a polyester film and a resin layer (X) provided on at least one side thereof, the resin layer (X) being a layer formed of a coating composition containing acrylic-urethane copolymer resin (a) and polyester resin with a naphthalene skeleton (b), and the film undergoing a change in the film haze, ΔHz, of less than 3.0% during boiling treatment test (ΔHz=film haze before and after boiling treatment test−film haze before boiling treatment test).

Alternatively, the laminated polyester film according to the present invention is a laminated polyester film including a polyester film and a resin layer (X) provided on at least one side thereof, the resin layer (X) being a layer formed of a coating composition containing acrylic-urethane copolymer resin (a), polyester resin with a naphthalene skeleton (b), an isocyanate compound (c), a carbodiimide compound (d), and an oxazoline compound (e), and the aggregate that contains the acrylic-urethane copolymer resin (a) in the layer (X) having a dispersion index of 5 or less.

The above laminated polyester film according to the present invention is high in transparency and ability to depress the iris-like pattern (interference pattern) that occurs after lamination with a hard coat layer (to maintain visibility), high in initial adhesiveness to a hard coat layer, strong adhesion in a wet-heat-resistant environment (wet-heat-resistant adhesiveness), and adhesiveness after UV irradiation (UV-resistant adhesiveness), high in adhesiveness after immersion in boiling water (boiling-resistant adhesiveness), and high in ability to depress the deterioration in transparency (transparency reduction) when immersed in boiling water (boiling-resistant transparency).

It is also preferable for the polyester resin (b) to be a copolymer polyester resin in which aromatic dicarboxylic acid components containing a metal sulfonate group account for 1 to 30 mol % of the total quantity of the dicarboxylic acid components of the polyester. Furthermore, it is more preferable for the above polyester resin (b) to contain a diol component that is expressed by Formula (1) given below.

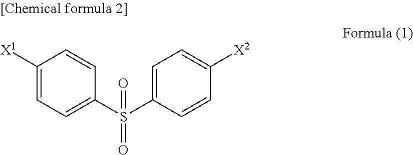

Here, X¹ and X² are —(CₙH₂ₙO)ₘ—H; n is an integer of 2 or more and 4 or less; and m is an integer of 1 or more and 15 or less.

Here, the change in film haze, ΔHz, between before and after boiling treatment test for the present invention is the quantity of a change between the film haze measurements made before and after boiling treatment test in which the laminated polyester film is immersed in boiling water at 100° C. Specifically, the change in film haze, ΔHz, between before and after boiling treatment test is calculated by subtracting the haze value of the laminated polyester film before the boiling treatment test from the haze value of the laminated polyester film after the boiling treatment test (ΔHz=film haze after boiling treatment test−film haze before boiling treatment test). A detailed measuring procedure will be described later.

For the laminated polyester film according to the present invention, it is necessary that the change in film haze, ΔHz, between before and after boiling treatment test be less than 3.0%. If the change in film haze, ΔHz, between before and after boiling treatment test is less than 3.0%, the laminated polyester film will not suffer a significant deterioration in transparency even when used in a harsh (such as high temperature, high humidity) environment for a long period of time. The change in film haze, ΔHz, between before and after boiling treatment test is more preferably less than 2.5%.

Methods for producing a laminated polyester film for which the change in film haze, ΔHz, between before and after boiling treatment test less than 3.0% include, for example, a method in which a copolymer polyester resin in which aromatic dicarboxylic acid components containing a metal sulfonate group account for 1 to 30 mol % of the total quantity of the dicarboxylic acid components of the polyester is used as the polyester resin (b) that is contained in the resin composition (a), a method in which the various resins (a) to (e) are added in the resin composition (a), a method in which the ratio among the resins (a) to (e) is maintained in a specific range, and a method in which the above methods are combined in various ways. Study by the present inventors suggests that this effect develops by the following mechanism. The inventors have found from investigations made so far that in the boiling treatment test, a laminated polyester film having a resin layer suffers the generation of fine voids at the surface of the resin layer, leading to a deterioration in transparency (an increase in haze) of the laminated polyester film. As the number of these voids increases, the transparency deteriorates (the haze increases) and the adhesiveness decreases. It is inferred from this that components contributing the adhesion bleed in the boiling treatment test. Implementation of a method in which a copolymer polyester resin in which aromatic dicarboxylic acid components containing a metal sulfonate group account for 1 to 30 mol % of the total quantity of the dicarboxylic acid components of the polyester is used as the polyester resin (b) that is contained in the resin composition (a) or a method in which the various resins (a) to (e) are added in the resin composition (a) makes it possible to improve the compatibility between the polyester resin (b) and other resins and thereby produce a resin layer having a uniformly dispersed structure. In particular, resin layers formed by these methods will be high in the degree of crosslinking and will not bleed significantly in the boiling treatment test. It is presumed that as a result of this, the formation of fine voids at the surface of the resin layer is depressed in the boiling treatment test, leading to a large decrease in the change in haze.

Here, the dispersion index as referred to for the present invention is the average number of aggregates measuring 40 nm or more and containing acrylic-urethane copolymer resin (a) that are found in an area of a specific size in a cross section of the resin layer (X) observed by transmission electron microscopy (TEM). An area of a specific size (1,200 nm×500 nm) in the field of view is observed at a magnification of 20,000×, and the number of aggregates measuring 40 nm or more and containing acrylic-urethane copolymer resin is counted. This observation is performed for 10 areas and the average number of aggregates existing per area (1,200 nm×500 nm) is rounded off to the whole number to give the dispersion index. Here, the size of an aggregate is defined as the maximum size across the aggregate (i.e., the length of the aggregate or the major axis of the aggregate). The maximum size across the aggregate is determined in the same way even if the aggregate contains a hollow.

The dispersion index is integer of 0 or more. For the present invention, it is necessary for the dispersion index to be 5 or less, preferably 4 or less, and more preferably 3 or less.

To determine if the dispersion index of the resin layer (X) meets the requirement of 5 or less, the cross-sectional structure of the layer (X) is observed by transmission electron microscopy (TEM).

First, cross-sectional observation of the resin layer (X) is described.

A specimen for cross-sectional observation of the layer (X) of a laminated polyester film is prepared by RuO4-dyeing ultramicrotomy. The cross section of the specimen thus obtained is observed at a magnification of 20,000× under an accelerating voltage of 100 kV to examine an area (1,200 nm×500 nm) in the field of view. For example, structures as illustrated in FIG. 1 to FIG. 3 may be found.

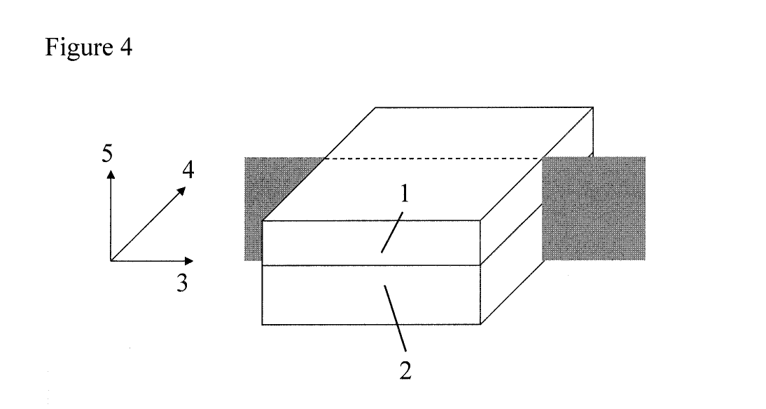

Here, cross-sectional observation of the resin layer (X) means observing the cross section that is indicated as X-Z in FIG. 4. Here, the dyeing with RuO₄ makes it possible to dye parts having acrylic skeletons.

For example, if a specimen is prepared by the same procedure from a laminated polyester film having a resin layer (X) that consists only of a polyester resin (b) with a naphthalene skeleton, an isocyanate compound (c), a carbodiimide compound (d), and an oxazoline compound (e), it does not contain an acrylic-urethane copolymer resin (a) that can be dyed with RuO₄ and accordingly, the cross section under observation contains no black parts. If a specimen is prepared by the same procedure from a laminated polyester film formed only of an acrylic-urethane copolymer resin (a), on the other hand, it contains only the acrylic-urethane copolymer resin (a) that can be dyed with RuO₄ and accordingly, only an entirely black cross section is seen in the observation. These results show that the black parts are those which contain an acrylic-urethane resin (a).

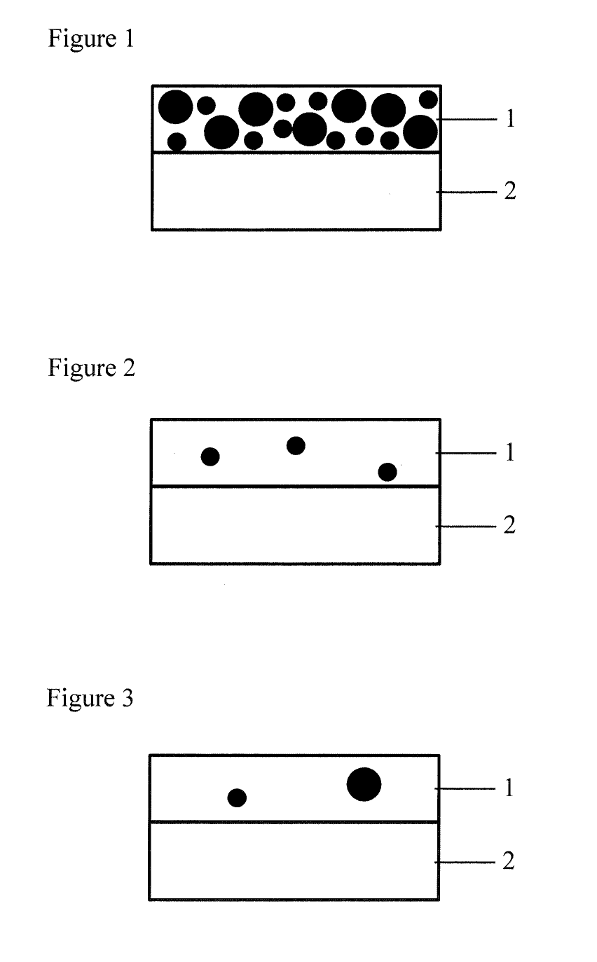

If the layer (X) has a sea-island structure as given in FIG. 1, the number of islands of the black parts (containing, for example, acrylic-urethane copolymer resin) in the thickness direction of the layer (X) is larger and the dispersion index is greater as compared with the structures given in FIG. 2 or FIG. 3. In the case of the structures given in FIGS. 2 and 3, on the other hand, the number of the islands of the black parts is smaller and accordingly, the dispersion index is also smaller.

If the dispersion index determined by the observation procedure described above is more than 5, it is presumed that the resin layer (X) does not have a uniformly dispersed structure. If the dispersion index is 5 or less, on the other hand, it is presumed that the resin layer (X) has a uniformly dispersed structure.

If the resin layer (X) is a layer formed of a coating composition containing acrylic-urethane copolymer resin (a), polyester resin with a naphthalene skeleton (b), an isocyanate compound (c), a carbodiimide compound (d), and an oxazoline compound (e) and if the aggregates that contain the acrylic-urethane copolymer resin (a) in the layer (X) have a dispersion index of 5 or less, the laminated polyester film according to the present invention can be high in transparency and ability to depress the iris-like pattern (interference pattern) likely to occur after lamination with a hard coat layer (to maintain visibility), high in initial adhesiveness to a hard coat layer, wet-heat-resistant adhesiveness, UV-resistant adhesiveness, and boiling-resistant adhesiveness, and surprisingly, also high in adhesiveness when immersed in boiling water (boiling-resistant adhesiveness) and ability to depress the deterioration in transparency (transparency reduction) when immersed in boiling water (boiling-resistant transparency).

Reasons for this are presumed as follows. If the acrylic-urethane copolymer resin (a) forms a uniformly dispersed structure with a dispersion index of 5 or less as in FIG. 2 and FIG. 3, the acrylic-urethane copolymer resin (a), which is high in adhesiveness to a hard coat layer, must be distributed over the surface of the resin layer (X). In addition, an isocyanate compound (c) which is high in adhesiveness to a hard coat layer, a carbodiimide compound (d), and an oxazoline compound (e) must be also distributed over the surface of the layer (X). As a result, the layer (X) will have large interaction with the hard coat layer to cause a large increase in the adhesion to the hard coat layer. In addition, if a peeling force is applied to the hard coat layer, the stress is decentralized, instead of being locally concentrated, due to uniform in-plane adhesive strength, thus leading to high wet-heat-resistant adhesiveness, UV-resistant adhesiveness, boiling-resistant adhesiveness, and boiling-resistant transparency. Furthermore, if acrylic-urethane copolymer resin (a) forms a uniformly dispersed structure in the resin layer (X), it prevents the local concentration of the acrylic-urethane copolymer resin (a) which is low in refractive index, leading to a uniform refractive index over the layer (X). Thus, the resulting layer (X) will be uniform in refractive index in the thickness of direction. As a result, lamination with a hard coat layer improves the ability to depress the iris-like pattern (interference pattern) (visibility), which is preferable.

If the dispersion index is more than 5, on the other hand, inferior mutual dispersion occurs between the resins, resulting in a decrease in transparency, wet-heat-resistant adhesiveness, UV-resistant adhesiveness, boiling-resistant adhesiveness, and boiling-resistant transparency.

For the present invention, there are some techniques that can form a uniformly dispersed structure with a dispersion index of 5 or less in a resin layer (X). For example, as described below, a structure with a dispersion index of 5 or less can be formed in a resin layer (X) by using, as a polyester resin (b) with a naphthalene skeleton, a copolymer polyester resin in which aromatic dicarboxylic acid components containing a metal sulfonate group account for 1 to 30 mol % of the total quantity of the dicarboxylic acid components of the polyester while the ratio among the resins (a) to (e) in the coating composition is maintained in a specific range.

In addition, in the laminated polyester film according to the present invention, the minimum value of the spectral reflectance of the resin layer (X) in the wavelength range of 450 nm or more and 650 nm or less is preferably 4.5% or more and 6.0% or less.

In regard to the production of a laminated polyester film for the present invention in which the minimum value of the spectral reflectance of the resin layer (X) in the wavelength range of 450 nm or more and 650 nm or less is 4.5% or more and 6.0% or less, a typical technique is to use, as the polyester resin (b) with a naphthalene skeleton, a copolymer polyester resin in which aromatic dicarboxylic acid components containing a metal sulfonate group account for 1 to 30 mol % of the total quantity of the dicarboxylic acid components of the polyester while the ratio among the resins (a) to (e) in the coating composition is maintained in a specific range. This makes it possible to produce a laminated polyester film in which the minimum value of the spectral reflectance of the layer (X) in the wavelength range of 450 nm or more and 650 nm or less is 4.5% or more and 6.0% or less.

This is because, for example, the use, as the polyester resin (b) with a naphthalene skeleton, of a copolymer polyester resin in which aromatic dicarboxylic acid components containing a metal sulfonate group account for 1 to 30 mol % of the total quantity of the dicarboxylic acid components of the polyester improves the compatibility between the acrylic-urethane copolymer resin (a) and other resins, allowing a uniformly dispersed structure to be formed. As a result, the refractive index becomes uniform over the resin layer (X) and it becomes possible to produce a laminated polyester film in which the minimum value of the spectral reflectance of the resin layer (X) in the wavelength range of 450 nm or more and 650 nm or less is 4.5% or more and 6.0% or less. A reflectance in this range is preferable because when the film is laminated with a hard coat layer, the iris-like pattern (interference pattern) can be depressed (visibility is improved) through the mechanism of optical interference. The reason is described in detail below. The depression of the formation of an iris-like pattern can be achieved by controlling the refractive index and film thickness of the resin layer (X). The formation of an iris-like pattern is depressed most effectively when the refractive index of the resin layer (X) is equal to the geometric mean of the refractive index of the polyester film used as the base and that of the hard coat layer used for lamination. In the case where the hard coat layer is of acrylic resin while the polyester film used as the base is of polyethylene terephthalate, for example, the hard coat layer has a refractive index of 1.52 and the polyester film, i.e., the base, has a refractive index of 1.65. Accordingly, the optimum refractive index of the resin layer (X) to depress the iris-like pattern formation is their geometric mean, that is, 1.58. Since there is a correlation between the refractive index of a coat film and its reflectance in the wavelength range 450 nm or more and 650 nm or less, the depression of the formation of an iris-like pattern can be made possible by using a laminated polyester film in which the reflectance of the resin layer (X) in the wavelength range of 450 nm or more and 650 nm or less is 4.5% or more and 6.0% or less.

For the laminated polyester film according to the present invention, furthermore, the laminated polyester film with the resin layer (X) is formed preferably by coating at least one side of a polyester film with a coating composition composed of an acrylic-urethane copolymer resin (a) and a polyester resin (b) mixed at a solid content ratio by weight of 40/60 to 5/95, which is preferable because good adhesion develops between the laminated polyester film and a hard coat layer. Furthermore, the laminated polyester film is preferably produced by forming the resin layer (X) by applying a coating composition containing 3 to 20 parts (as solid content by weight) of an isocyanate compound (c), 10 to 40 parts (as solid content by weight) of a carbodiimide compound (d), and 10 to 40 parts (as solid content by weight) of an oxazoline compound (e) relative to the total solid content by weight, which accounts for 100 parts by weight, of the acrylic-urethane copolymer resin (a) and the polyester resin (b), which is preferable because it is possible to produce a laminated polyester film with a uniformly dispersed structure in which the dispersion index for the acrylic-urethane copolymer resin (a) in the resin layer (X) is 5 or less to allow the laminated polyester film to have a high wet-heat-resistant adhesiveness, UV-resistant adhesiveness, boiling-resistant adhesiveness, and boiling-resistant transparency.

As a result, the resin layer can be high in transparency, adhesiveness to a hard coat layer, UV-resistant adhesiveness, boiling-resistant adhesiveness, and ability to depress the interference pattern likely to occur after lamination with a hard coat layer (to maintain visibility).

Described below are the acrylic-urethane copolymer resin (a), polyester resin with a naphthalene skeleton (b), isocyanate compound (c), carbodiimide compound (d), and oxazoline compound (e) that are used to produce the laminated polyester film according to the present invention.

### (1) Acrylic-Urethane Copolymer Resin (a)

There are no specific limitations on the acrylic-urethane copolymer resin (a) used in the laminated polyester film according to the present invention as long as it is a resin produced through copolymerization of an acrylic resin and an urethane resin.

The acrylic resin to be used for the present invention is a resin that is produced by copolymerizing an acrylic monomer as described later with other monomers as required, by a generally known acrylic resin polymerization method such as emulsion polymerization and suspension polymerization.

Acrylic monomers that can be used to produce an acrylic-urethane copolymer resin (a) include, for example, hydroxy group-containing monomers such as alkyl acrylates (alkyl group may be methyl, ethyl, n-propyl, n-butyl, isobutyl, t-butyl, 2-ethylhexyl, cyclohexyl, or the like), alkyl methacrylates (alkyl group may be methyl, ethyl, n-propyl, n-butyl, isobutyl, t-butyl, 2-ethylhexyl, cyclohexyl, or the like), 2-hydroxyethyl acrylate, 2-hydroxyethyl methacrylate, 2-hydroxypropyl acrylate, and 2-hydroxypropyl methacrylate; amide group-containing monomers such as acrylamide, methacrylamide, N-methyl methacrylamide, N-methyl acrylamide, N-methylol acrylamide, N-methyl methacrylamide, N,N-dimethylol acrylamide, N-methoxymethyl acrylamide, N-methoxymethyl methacrylamide, N-butoxymethyl acrylamide, and N-phenyl acrylamide; amino group-containing monomers such as N,N-diethylaminoethyl acrylate and N,N-diethylaminoethyl methacrylate; glycidyl group-containing monomers such as glycidyl acrylate and glycidyl methacrylate; and carboxyl group- or salt thereof-containing monomers such as acrylic acid, methacrylic acid, and salts thereof (sodium salt, potassium salt, ammonium salt, and the like).

An acrylic resin can be produced by polymerizing one or more types of acrylic monomers and if monomers other than acrylic monomers are used in combination, it is preferable for the acrylic monomers to account for 50 wt % or more, preferably 70 wt % or more, of all the monomers from the viewpoint of adhesiveness.

The urethane resin used for the present invention can be produced by reacting a polyhydroxy compound with a polyisocyanate compound by a generally known urethane resin polymerization method such as emulsion polymerization and suspension polymerization.

Examples of such a polyhydroxy compound include, for example, polyethylene glycol, polypropylene glycol, polyethylene propylene glycol, polytetramethylene glycol, hexamethylene glycol, tetramethylene glycol, 1,5-pentanediol, diethylene glycol, triethylene glycol, polycaprolactone, polyhexamethylene adipate, polyhexamethylene sebacate, polytetramethylene adipate, polytetramethylene sebacate, trimethylol propane, trimethylol ethane, pentaerythritol, polycarbonate diol, and glycerin.

Examples of such a polyisocyanate compound include, for example, hexamethylene diisocyanate, diphenyl methane diisocyanate, tolylene diisocyanate, isophorone diisocyanate, addition products of tolylene diisocyanate and trimethylene propane, and addition products of hexamethylene diisocyanate and trimethylol ethane.

If an in-line coating technique as described later is used to form the resin layer (X), the acrylic-urethane copolymer resin (a) is preferably one that can be dissolved or dispersed in water. A useful technique to increase the affinity of an acrylic-urethane copolymer resin with water is to use, for example, a carboxylic acid group-containing polyhydroxy compound or hydroxyl group-containing carboxylic acid as one of the polyhydroxy compounds. Examples of such a carboxylic acid group-containing polyhydroxy compound include, for example, dimethylol propionic acid, dimethylol butyric acid, dimethylol valeric acid, and trimellitic acid bis(ethylene glycol) ester. Examples of such a hydroxyl group-containing carboxylic acid include, for example, 3-hydroxypropionic acid, γ-hydroxybutyric acid, p-(2-hydroxyethyl)benzoic acid, and malic acid.

Another technique to increase the affinity of an acrylic-urethane copolymer resin with water is to introduce a sulfonate group into the urethane resin. For example, a prepolymer is produced from a polyhydroxy compound, polyisocyanate compound, and chain extension agent, and a compound containing, in one molecule, an amino group or hydroxyl group that is reactive with the terminal isocyanate group as well as a sulfonate group or sulfate half ester salt group is added to and reacted with it, thereby finally producing a urethane resin containing a sulfonate group or sulfate half ester salt group in one molecule. Examples of such a compound containing, in one molecule, an amino group or hydroxyl group that is reactive with the terminal isocyanate group, as well as a sulfonate group, include, for example, aminomethane sulfonic acid, 2-aminoethane sulfonic acid, 2-amino-5-methylbenzene-2-sulfonic acid, sodium β-hydroxyethane sulfonate, and addition products of propane sultone, butane sultone, etc. to an aliphatic primary amine compound, of which addition products of propane sultone to an aliphatic primary amine compound are preferable.

The acrylic-urethane copolymer resin (a) is preferably an acrylic-urethane copolymer resin containing an acrylic resin as skin layer and a urethane resin as core layer because of high adhesiveness to a hard coat layer. It is particularly preferable that it have a structure in which the core layer formed of urethane resin is exposed instead of being completely covered by the skin layer formed of acrylic resin. If the core layer is completely covered by the skin layer, the resin layer (X) existing at the surface has only the features of acrylic resin and it will be difficult to allow the surface to show features attributable to the urethane resin of the core layer, which is not preferable from the viewpoint of the adhesiveness to a hard coat layer. On the other hand, if the core layer is not covered at all by the skin layer, or if the two components are separated from each other, the acrylic resin and the urethane resin are in a simply mixed state. In that state, the acrylic resin, which is the smaller in surface energy, will tend to be selectively located near the surface (which is exposed to air) of the resin layer (X). As a result, the surface of the resin layer (X) will show only features of the acrylic resin, which is not preferable from the viewpoint of the adhesiveness to a hard coat layer.

Described below is a technique to produce a acrylic-urethane copolymer resin (a) with a core-skin structure. First, a first stage emulsion polymerization is performed using a monomer for the urethane resin that will form the core parts in the intended polymer resin, in combination with an emulsifier, polymerization initiator, and aqueous solvent. Then, after the first stage emulsion polymerization has virtually completed, an acrylic monomer to form the skin parts and a polymerization initiator are added and the second stage emulsion polymerization is carried out. An acrylic-urethane copolymer resin with a core-skin structure can be produced through this two-stage reaction. To produce here a copolymer resin with a two layer structure consisting of a core layer and a skin layer, a useful technique is to add the emulsifier in the second stage emulsion polymerization only to such an extent that new cores are not formed so that polymerization progresses only at the surface of the cores of the urethane resin produced in the first stage emulsion polymerization.

A production method for an acrylic-urethane copolymer resin (a) is described below, but the invention is not construed as being limited to the method. For example, a small amount of a dispersing agent and a polymerization initiator are added to an aqueous dispersion of urethane resin and an acrylic monomer is added little by little while stirring and maintaining a constant temperature. Afterwards, the temperature is raised if necessary and the reaction is continued for a required period of time to complete the polymerization of the acrylic monomer to provide an aqueous dispersion of an acrylic-urethane copolymer resin.

The acrylic-urethane copolymer resin (a) in the coating composition preferably accounts for 1 wt % or more and 25 wt % or less, more preferably 3 wt % or more and 20 wt % or less, of the total weight of solid resin contents in the coating composition. Its content is particularly preferably 5 wt % or more and 10 wt % or less.

The acrylic resin in the acrylic-urethane copolymer resin (a) preferably has a glass transition temperature (hereinafter, the glass transition temperature is referred to as Tg) of 20° C. or more, more preferably 40° C. or more. If the acrylic resin has a Tg of 20° C. or more, it is preferable because the resin can show improved blocking properties during storage at room temperature.

The content ratio by weight between the acrylic resin and the urethane resin (acrylic resin/urethane resin) in the acrylic-urethane copolymer resin (a) is preferably 10/90 to 70/30, more preferably 20/80 to 50/50. If the ratio is outside this range, the adhesiveness between the laminated polyester film and the hard coat layer may deteriorate. The content ratio by weight between the acrylic resin and the urethane resin can be adjusted to a desired value by controlling their feed quantities at the time of the production of the acrylic-urethane copolymer resin (a).

Furthermore, the solid content ratio by weight between the acrylic-urethane copolymer resin (a) and the polyester resin (b) in the coating composition is preferably 40/60 to 5/95 in order to ensure strong adhesion between the laminated polyester film and the hard coat layer. It is more preferably 30/70 to 10/90.

(2) Polyester Resin (b) with a Naphthalene Skeleton

For the present invention, the polyester resin (b) with a naphthalene skeleton is a polyester resin containing a naphthalene skeleton in which ester bonds are the major bonds in the backbone chain.

For example, a method to obtain a polyester resin with a naphthalene skeleton is the use, as an input material for producing the polyester resin, a diol component or multivalent hydroxyl group component in which the naphthalene ring has two or more hydroxyl groups introduced as substituent groups or a dicarboxylic acid component or multivalent carboxylic acid component containing two or more carboxylic acid groups or ester-forming derivatives of carboxylic acid. From the viewpoint of the stability of the polyester resin, it is preferable that for producing a polyester resin with a naphthalene skeleton, a dicarboxylic acid component in which the naphthalene ring contains two carboxylic acid groups be used as an input material for polyester resin. Examples having a naphthalene skeleton containing two carboxylic acid groups include, for example, aromatic dicarboxylic acids such as 2,6-naphthalene dicarboxylic acid, 2,3-naphthalene dicarboxylic acid, 1,4-naphthalene dicarboxylic acid, 1,5-naphthalene dicarboxylic acid, and 2,7-naphthalene dicarboxylic acid; and ester-forming derivatives of aromatic dicarboxylic acid such as 2,6-dimethyl naphthalene dicarboxylate, 2,6-diethyl naphthalene dicarboxylate, 1,4-dimethyl naphthalene dicarboxylate, and 1,4-diethyl naphthalene dicarboxylate. Of these, 2,6-naphthalene dicarboxylic acid and ester-forming derivatives of 2,6-naphthalene dicarboxylic acid are particularly preferable from the viewpoint of the refractive index and dispersibility with other resins.

The use of a polyester in which such dicarboxylic acid components with a naphthalene skeleton account for 30 mol % or more, more preferably 35 mol % or more, and still more preferably 40 mol % or more, of the total quantity of all the dicarboxylic acid components is preferable because the visibility can be improved.

Furthermore, multivalent carboxylic acids and multivalent hydroxyl compounds containing no naphthalene skeleton, such as those given below, may be used as constituent components of the polyester resin with a naphthalene skeleton (b). Specifically, examples of such a multivalent carboxylic acid include terephthalic acid, isophthalic acid, orthophthalic acid, phthalic acid, 4,4′-diphenyl carboxylic acid, 1,4-cyclohexanedicarboxylic acid, 2-potassium sulfoterephthalic acid, 5-sodium sulfoisophthalic acid, adipic acid, azelaic acid, sebacic acid, dodecane dicarboxylic acid, glutaric acid, succinic acid, trimellitic acid, trimesic acid, pyromellitic acid, trimellitic anhydride, phthalic anhydride, p-hydroxybenzoic acid, trimellitic acid monopotassium salt, and ester-forming derivatives thereof; and examples of such a multivalent hydroxyl compound include ethylene glycol, 1,2-propylene glycol, 1,3-propanediol, 1,4-butanediol, 1,6-hexanediol, 2-methyl-1,5-pentanediol, neopentyl glycol, 1,4-cyclohexanedimethanol, p-xylylene glycol, addition products of bisphenol A-ethylene glycol, diethylene glycol, triethylene glycol, polyethylene glycol, polypropylene glycol, polytetramethylene glycol, polytetramethylene oxide glycol, dimethylol propionic acid, glycerin, trimethylolpropane, sodium dimethylol ethyl sulfonate, and potassium dimethylol propionate.

It is also preferable for the polyester resin (b) used for the present invention to be a copolymer polyester resin in which aromatic dicarboxylic acid components containing a metal sulfonate group account for 1 to 30 mol % of the total quantity of the dicarboxylic acid components of the polyester. If it is less than 1 mol %, the polyester resin may lose water solubility and may decrease in the compatibility with the acrylic-urethane copolymer resin (a), isocyanate compound (c), carbodiimide compound (d), and oxazoline compound (e), leading to a decrease in the uniformity and transparency of the resin layer (X). If it is more than 30 mol %, the dispersibility with other resins may decrease, easily leading to deterioration in transparency, wet-heat-resistant adhesiveness, UV-resistant adhesiveness, boiling-resistant adhesiveness, and boiling-resistant transparency.

Examples of an aromatic dicarboxylic acid component containing a metal sulfonate group include, for example, compounds having a sulfonate group such as alkali metal salts of sulfophthalic acid, alkali metal salts of sulfoisophthalic acid, alkali metal salts of sulfoterephthalic acid, alkaline earth metal salts of sulfophthalic acid, alkaline earth metal salts of sulfoisophthalic acid, alkaline earth metal salts of sulfoterephthalic acid, alkali metal salts of sulfo-2,6-naphthalene dicarboxylic acid, alkali metal salts of sulfo-2,3-naphthalene dicarboxylic acid, alkali metal salts of sulfo-1,4-naphthalene dicarboxylic acid, alkaline earth metal salts of sulfo-2,6-naphthalene dicarboxylic acid, alkaline earth metal salts of sulfo-2,3-naphthalene dicarboxylic acid, and alkaline earth metal salt s of sulfo-1,4-naphthalene dicarboxylic acid.

Other examples of an aromatic dicarboxylic acid component containing a metal sulfonate group include, for example, salts of ester-forming derivatives of aromatic dicarboxylic acid containing a sulfonate group such as alkali metal salts of dimethyl sulfophthalate, alkali metal salts of sulfodimethyl isophthalate, alkali metal salts of sulfodimethyl terephthalate, alkaline earth metal salts of dimethyl sulfophthalate, alkaline earth metal salts of sulfodimethyl isophthalate, alkaline earth metal salts of sulfodimethyl terephthalate, alkali metal salts of sulfo-2,6-dimethyl naphthalene dicarboxylate, alkali metal salts of sulfo-2,3-dimethyl naphthalene dicarboxylate, alkali metal salts of sulfo-1,4-dimethyl naphthalene dicarboxylate, alkaline earth metal salts of sulfo-2,6-dimethyl naphthalene dicarboxylate, alkaline earth metal salts of sulfo-2,3-dimethyl naphthalene dicarboxylate, and alkaline earth metal salts of sulfo-1,4-dimethyl naphthalene dicarboxylate.

Of these, alkali metal salts of sulfoisophthalic acid, alkaline earth metal salts of sulfoisophthalic acid, and alkali metal salts and alkaline earth metal salts of ester-forming derivatives of sulfoisophthalic acid are particularly preferable.

Specific examples of the aforementioned alkali metal salts of sulfophthalic acid dimethyl include 5-sulfophthalic acid dimethyl lithium salt, 5-sulfophthalic acid dimethyl sodium salt, 5-sulfophthalic acid dimethyl potassium salt, and 5-sulfophthalic acid dimethyl cesium salt, and specific examples of the aforementioned alkaline earth metal salts of sulfophthalic acid dimethyl include bis(5-sulfophthalic acid dimethyl) magnesium, bis(5-sulfophthalic acid dimethyl) calcium, and bis(5-sulfophthalic acid dimethyl) barium. Similar alkali metal salts and alkaline earth metal salts of sulfodimethyl isophthalate and sulfodimethyl terephthalate can also be useful, though specific examples are not shown here.

Furthermore, as the dial component of the polyester resin, the polyester resin (b) used for the present invention preferably contains a diol component as represented by Formula (1) given below because it can improve the dispersibility with other resins and increase the visibility. The compound represented by Formula (1) given below has a bisphenol S skeleton, which contains the S element which is high in refractive index, and accordingly serves to increase the refractive index of the polyester resin (b). Even if a bisphenol compound that has a similar structure to Formula (1), such as bisphenol A, is used as diol component, it cannot serve so effectively to improve the dispersibility with other resins and visibility as compared with the diol components represented by Formula (1).

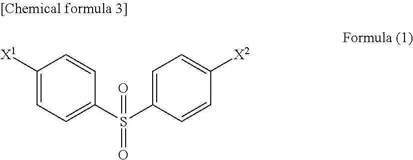

Here, X¹ and X² are —(CₙH₂ₙO)ₘ—H; n is an integer of 2 or more and 4 or less; and m is an integer of 1 or more and 15 or less.

Here, the oxyalkylene units in X¹ and X² contain 2 or more and 4 or less carbon atoms and they include oxyethylene unit, oxypropylene unit, oxybutylene unit, and/or oxytetramethylene unit, of which oxyethylene unit and/or oxypropylene unit (n=2 or 3) are preferable. Furthermore, the number of repetitions (m) of the oxyalkylene group is preferably 1 or more and 15 or less, more preferably 1 or more and 4 or less, and still more preferably 1 or 2.

The polyester resin (b) used for the present invention is preferably a copolymer polyester resin that contains 5 mol % or more and 50 mol % or less of diol components as represented by Formula (1) relative to the total quantity of the diol components in the polyester. More preferably, it is a copolymer polyester resin that contains 10 mol % or more and 40 mol % or less of them.

Furthermore, it is preferable for the polyester resin (b) to contain at least one diol compound as represented by Formula (2) in addition to the diol components represented by Formula (1).

HO—X³—H Formula (2)

(Here, X³ is —(CxH₂ₓO)y-; x is an integer of 2 or more and 10 or less; and y is an integer of 1 or more and 4 or less.)

Alkane diols containing 2 or more and 10 or less carbon atoms (x=2 or more and 10 or less) include, for example, ethylene glycol, 1,3-propanediol, 1,4-butanediol, 1,6-hexanediol, neopentyl glycol, 1,8-octanediol, and 1,10-decanediol, of which 1,3-propanediol and 1,4-butanediol (x=2 or 3) are preferable. The number of repetitions of the oxyalkylene group, y, is preferably 1 or more and 4 or less, more preferably 1 or more and 3 or less. The polyester resin (b) used for the present invention is preferably a copolymer polyester resin that contains 5 mol % or more and 50 mol % or less of diol components as represented by Formula (2) relative to the total quantity of the diol components in the polyester. More preferably, it is a copolymer polyester resin that contains 10 mol % or more and 40 mol % or less of them. The existence of such oxyalkylene groups is preferable because it serves to improve the hydrophilicity of the polyester resin (b) and improve the dispersibility with other resins.

Furthermore, there are no specific limitations on the intrinsic viscosity of the polyester resin (b) used for the present invention, but from the viewpoint of adhesiveness, it is preferably 0.3 dl/g or more and 2.0 dl/g or less, more preferably 0.4 dl/g or more and 1.0 dl/g or less. For the present invention, the intrinsic viscosity is measured by dissolving 0.3 g of polyester resin in 25 ml of a mixed solvent of phenol and tetrachloroethane mixed at a ratio by weight of 40/60 using a Cannon-Fenske viscometer at 35° C.

In addition, the polyester resin (b) used for the present invention preferably has a refractive index of 1.58 or more, more preferably 1.61 or more, and 1.65 or less. To determine the refractive index for the present invention, a resin plate specimen with a thickness of 0.5 mm is prepared by molding polyester resin in a small type hot press and measurements are made using an Abbe refractometer at 25° C. For the measurement, monobromonaphthalene was used as intermediate.

For the laminated polyester film according to the present invention, the polyester resin (b) can be produced by the production method described below. Available methods include, for example, an ester interchange—condensation polymerization reaction process in which dimethyl naphthalene dicarboxylate used as dicarboxylic acid component with a naphthalene skeleton, 5-sodium sulfodimethyl isophthalate as aromatic dicarboxylic acid component containing a metal sulfonate group, a compound produced by adding 2 moles of ethylene oxide to 1 mole of bisphenol S as diol component as represented by Formula (1), and ethylene glycol as diol component as represented by Formula (2) are subjected to ester interchange reaction in the presence of a generally known polymerization catalyst and then subjected to condensation polymerization reaction while evaporating low molecule compounds at a high temperature in a high vacuum; an ester interchange—condensation polymerization reaction—depolymerization reaction process in which dimethyl naphthalene dicarboxylate used as dicarboxylic acid component with a naphthalene skeleton, 5-sodium sulfodimethyl isophthalate as aromatic dicarboxylic acid component containing a metal sulfonate group, a compound produced by adding 2 moles of ethylene oxide to 1 mole of bisphenol S as diol component as represented by Formula (1), and ethylene glycol as diol component as represented by Formula (2) are subjected to ester interchange reaction in the presence of a generally known polymerization catalyst and then subjected to condensation polymerization reaction and depolymerization reaction while evaporating low molecule compounds at a high temperature in a high vacuum; and a condensation polymerization reaction process in which dimethyl naphthalene dicarboxylate used as dicarboxylic acid component with a naphthalene skeleton, 5-sodium sulfodimethyl isophthalate as aromatic dicarboxylic acid component containing a metal sulfonate group, a compound produced by adding 2 moles of ethylene oxide to 1 mole of bisphenol S as diol component as represented by Formula (1), and ethylene glycol as diol component as represented by Formula (2) are subjected to condensation polymerization reaction in the presence of a generally known polymerization catalyst while evaporating low molecule compounds at a high temperature in a high vacuum.

For these processes, usable reaction catalysts include, for example, alkali metals, alkaline earth metals, manganese, cobalt, zinc, antimony, germanium, and titanium compounds.

The polyester resin (b) preferably has a Tg of 0° C. or more and 130° C. or less, more preferably 10° C. to 85° C. If Tg is less than 0° C., wet-heat-resistant adhesiveness, boiling-resistant adhesiveness, boiling-resistant transparency, and the like may deteriorate or bonding between resin layers (X), i.e. blocking, may occur, whereas if it is more than 130° C., on the contrary, the resin may have inferior stability or poor water-dispersion properties.

### (3) Isocyanate Compound (c)

The isocyanate compound (c) for the present invention is an isocyanate compound (c) as given below or a compound containing a structure derived from an isocyanate compound (c) as given below.

Examples of such an isocyanate compound (c) include, for example, tolylene diisocyanate, diphenyl methane-4,4′-diisocyanate, meta-xylylene diisocyanate, hexamethylene-1,6-diisocyanate, 1,6-diisocyanate hexane, addition products of tolylene diisocyanate and hexanetriol, addition products of tolylene diisocyanate and trimethylolpropane, polyol modified diphenyl methane-4,4′-diisocyanate, carbodiimide modified diphenyl methane-4,4′-diisocyanate, isophorone diisocyanate, 1,5-naphthalene diisocyanate, 3,3′-bitolylene-4,4′-diisocyanate, 3,3′-dimethyl diphenyl methane-4,4′-diisocyanate, and meta-phenilene diisocyanate. In particular, polymeric isocyanate compounds having a plurality of isocyanate groups at chain ends and in side chains of a polymer such as polyester resin and acrylic resins are used preferably because the toughness of the layer (X) can be increased.

If the resin layer (X) is to be produced by the in-line coating technique described later, the isocyanate compound (c) is preferably in the form of an aqueous dispersion. In particular, from the viewpoint of producing a coating composition with a required pot life, it is particularly preferable to use a blocked isocyanate based compound in which the isocyanate group is blocked with a blocking agent. In a known crosslinking reaction process involving a blocking agent, the heat used for drying after coating works to vaporize the blocking agent and expose isocyanate groups, thereby causing crosslinked reaction. Here, the isocyanate group may be either a monofunctional one or a polyfunctional one, but the use of a polyfunctional type blocked polyisocyanate based compound is preferable because the crosslink density in the layer (X) increases, leading to improvement in the wet-heat-resistant adhesiveness to a hard coat layer, UV-resistant adhesiveness, boiling-resistant adhesiveness, and boiling-resistant transparency.

Examples of low-molecular-weight or polymeric compounds having two or more blocked isocyanate groups include, for example, tolylene diisocyanate, hexamethylene diisocyanate, addition products of 3 moles of tolylene diisocyanate to trimethylolpropane, polyvinyl isocyanate, vinyl-isocyanate copolymer, polyurethane-terminated diisocyanate, tolylene diisocyanate blocked by methyl ethyl ketone oxime, hexamethylene diisocyanate blocked by sodium hyposulfite, polyurethane-terminated diisocyanate blocked by methyl ethyl ketone oxime, and phenol-blocked addition products of 3 moles of tolylene diisocyanate to trimethylolpropane.

The coating composition preferably contains 3 parts by weight or more and 20 parts by weight or less, more preferably 4 parts by weight or more and 18 parts by weight or less, and still more preferably 5 parts by weight or more and 16 parts by weight or less, of the isocyanate compound (c) relative to the total quantity, or 100 parts by weight, of the acrylic-urethane copolymerization resin (a) and the polyester resin (b).

If the content of the isocyanate compound (c) is in the above range while the total content of the carbodiimide compound (d) and oxazoline compound (e) is in a predetermined range, the resin layer (X) can be high in transparency, moist heat adhesiveness, boiling-resistant adhesiveness, boiling-resistant transparency, and visibility. If the coating composition contains less than 3 parts by weight of the isocyanate compound (c), the adhesiveness to a hard coat layer may be small in some cases. If the content is more than 20 parts by weight, the laminated polyester film may be low in transparency and in addition, the resin layer may be low in refractive index, possibly causing a decrease in visibility after lamination with a hard coat layer.

### (4) Carbodiimide Compound (d)

There are no specific limitations on the carbodiimide compound (d) to be used for the present invention as long as, for example, at least one or more of a carbodiimide structure as represented by the general formula (3) given below are contained in one molecule. A polycarbodiimide compound containing two or more of it per molecule is particularly preferable from the viewpoint of wet-heat-resistant adhesiveness, boiling-resistant adhesiveness, boiling-resistant transparency, and the like. In particular, polymeric isocyanate compounds having a plurality of carbodiimide groups at chain ends and in side chains of a polymer such as polyester resin and acrylic resins are used preferably because when the layer (X) according to the present invention is formed on a polyester film to produce a laminated polyester film, the layer (X) can have increased flexibility and toughness.

—N═C═N— Formula (3)

Production of a polycarbodiimide compound can be achieved by using a generally known technique and commonly, it can be produced through condensation polymerization of a diisocyanate compound in the presence of a catalyst. Diisocyanate compounds that can be used as starting material for producing a polycarbodiimide compound include aromatic, aliphatic, and alicyclic diisocyanates, and specific examples include tolylene diisocyanate, xylene diisocyanate, diphenyl methane diisocyanate, hexamethylene diisocyanate, cyclohexane diisocyanate, isophorone diisocyanate, and dicyclohexyl diisocyanate. A surface active agent and hydrophilic monomers such as polyalkylene oxide, quaternary ammonium salt of dialkyl aminoalcohol, and hydroxyalkyl sulfonate may be added to improve the water solubility and water dispersibility of the polycarbodiimide compound unless they impair the advantageous effect of the invention.

The content of the carbodiimide compound (d) is preferably 10 to 40 parts by weight relative to the total content, or 100 parts by weight, of the components of (a) and (b) in the coating composition. If it is in the range of 10 to 40 parts by weight, a laminated polyester film that is high in wet-heat-resistant adhesiveness, boiling-resistant adhesiveness, and boiling-resistant transparency can be obtained when the laminated polyester film is produced by forming a polyester film on the resin layer (X) according to the present invention.

If a carbodiimide compound (d) and an oxazoline compound (e) are used in combination, it is possible to obtain a laminated polyester film very high in wet-heat-resistant adhesiveness, boiling-resistant adhesiveness, and boiling-resistant transparency that cannot be produced when either of them is used singly.

### (5) Oxazoline Compound (e)

There are no specific limitations on the oxazoline compound (e) used for the present invention as long as at least one or more oxazoline groups or oxazine groups are contained in one molecule, but it is preferably a polymeric one produced through homopolymerization of an addition-polymerizable, oxazoline group-containing monomer or through copolymerization thereof with another monomer. This is because when a laminated polyester film is produced by forming the layer (X) according to the present invention on a thermoplastic resin film, the use of a polymeric oxazoline compound serves to form a layer (X) having increased flexibility, toughness, water resistance, and solvent resistance.

Examples of such an addition-polymerizable, oxazoline group-containing monomer include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, and 2-isopropenyl-5-ethyl-2-oxazoline. These can be used singly or as a mixture of a plurality thereof In particular, 2-isopropenyl-2-oxazoline is preferred because it is high in industrial availability There are no specific limitations on other monomers as long as they can copolymerize with addition-polymerizable, oxazoline group-containing monomers and their examples include, for example, (meth)acrylic esters such as alkyl acrylates and alkyl methacrylates (the alkyl group contained may be a methyl group, ethyl group, n-propyl group, isopropyl group, n-butyl group, isobutyl group, t-butyl group, 2-ethylhexyl group, or cyclohexyl group); unsaturated carboxylic acids such as acrylic acid, methacrylic acid, itaconic acid, maleic acid, fumaric acid, crotonic acid, styrene sulfonic acid, and salts thereof (sodium salts, potassium salts, ammonium salts, tertiary amine salts, etc.); unsaturated nitriles such as acrylonitriles and methacrylonitriles; unsaturated amides such as acrylamides, methacrylamides, N-alkyl acrylamides, N-alkyl methacrylamides, N,N-dialkyl acrylamides, N,N-dialkyl methacrylate (the alkyl group contained may be a methyl group, ethyl group, n-propyl group, isopropyl group, n-butyl group, isobutyl group, t-butyl group, 2-ethylhexyl group, cyclohexyl group, or the like); vinyl esters such as vinyl acetates, vinyl propionates, and compounds produced by adding a polyalkylene oxide to the ester part of an acrylic acid or methacrylic acid; vinyl ethers such as methyl vinyl ether and ethyl vinyl ether; α-olefins such as ethylene and propylene; halogen-containing α,β-unsaturated monomers such as vinyl chloride, vinylidene chloride, and vinyl fluoride; and α,β-unsaturated aromatic monomers such as styrene and α-methyl styrene, which may be used singly or as a mixture of a plurality thereof.

The content of the oxazoline compound (e) is preferably 10 to 40 parts by weight relative to the total content, or 100 parts by weight, of the components of (a) and (b) in the coating composition. If it is in the range of 10 to 40 parts by weight, a laminated polyester film that is high in wet-heat-resistant adhesiveness, UV-resistant adhesiveness, and boiling-resistant adhesiveness can be obtained when the laminated polyester film is produced by forming a polyester film on the resin layer (X) according to the present invention.

### (6) Melamine Compound (f)

The resin layer (X) according to the present invention may be one formed from a coating composition further containing a melamine compound (f).

There are no specific limitations on the melamine compound (f), but from the viewpoint of hydrophilicity, preferred ones include those compounds that are produced by condensing melamine and formaldehyde into a methylol melamine derivative and then etherifying it through dehydration condensation reaction with a lower alcohol such as methyl alcohol, ethyl alcohol, and isopropyl alcohol.

Examples of such a methylolated melamine derivative include, for example, monomethylol melamine, dimethylol melamine, trimethylol melamine, tetramethylol melamine, pentamethylol melamine, and hexamethylol melamine.

If the resin layer (X) according to the present invention is one formed from a coating composition containing the melamine compound (f), it is preferable for ensuring high adhesiveness, but a large content of a melamine compound in the coating composition can cause problems such as process contamination due to volatilization of the melamine compound in the production process and generation of formaldehyde, which is harmful to human health, as a result of crosslinking reaction involving the melamine compound. Accordingly, the content of the melamine compound (f) is preferably 30 parts by weight or less relative to the total content, or 100 parts by weight, of the components of (a) and (b) in the coating composition. It is more preferably 5 parts by weight or more and 30 parts by weight or less, and particularly preferably 10 parts by weight or more and 25 parts by weight or less.

When the layer (x) according to the present invention is formed on the polyester film to produce a laminated polyester film, the use of 5 parts by weight or more and 30 parts by weight or less of the melamine compound (f) further increases the adhesiveness of the laminated polyester film to a hard coat layer.

### (7) Formation Method for Resin Layer (X)

For the present invention, a coating composition containing the acrylic-urethane copolymer resin (a), polyester resin (b), isocyanate compound (c), carbodiimide compound (d), and oxazoline compound (e), as well as the melamine compound (f) and a solvent as required is applied to a polyester film and the solvent is removed by drying as required, thereby forming the resin layer (X) on a polyester film.

For the present invention, furthermore, the solvent used is preferably an aqueous solvent (g). The use of an aqueous solvent serves to depress rapid evaporation of the solvent during the drying step, form a uniform resin layer (X), and prevent environment loads from being caused.

Here, the aqueous solvent (g) is water or a mixture of water and a water-soluble organic solvent such as alcohol (methanol, ethanol, isopropyl alcohol, butanol, or the like), ketone (acetone, methyl ethyl ketone, or the like), glycol (ethylene glycol, diethylene glycol, propylene glycol, or the like), mixed at an appropriate ratio. The use of an aqueous solvent serves to depress rapid evaporation of the solvent during the drying step and form a uniform resin layer. It also serves to prevent environment loads from being caused.

The application of the coating composition to the polyester film may be carried out by either in-line coating or off-line coating, of which in-line coating is preferable.

In-line coating is a method in which coating is performed in the polyester film production process. Specifically, coating is performed at any step in the process in which a polyester resin is melt-extruded, biaxially stretched, heat-treated, and wound up, and commonly, the coating composition is applied to any of the following: the substantially amorphous, unstretched (unoriented) polyester film resulting from melt extrusion and subsequent quenching (hereinafter referred to as film A), uniaxially stretched (uniaxially oriented) polyester film resulting from subsequent stretching in the length direction (hereinafter referred to as film B), and biaxially stretched (biaxially orientated) polyester film resulting from further stretching in the width direction prior to heat treatment (hereinafter referred to as film C).

For the present invention, it is preferable to adopt a method in which the coating composition is applied to any of films A, B, and C described above, in which crystal orientation has not completed, followed by stretching the polyester film uniaxially or biaxially, and heat treatment at a temperature higher than the boiling point of the solvent to complete the crystal orientation in the polyester film and simultaneously form the resin layer (X). This method allows the production of a polyester film and the application and drying of a coating composition (that is, the formation of a resin layer (X)) to be performed simultaneously to ensure advantages in terms of production cost. Furthermore, the thickness of the resin layer (X) can be decreased because stretching is performed after coating. From the viewpoint of visibility, the thickness of the resin layer (X) is preferable such that the optical interference is cancelled, and specifically, it is 50 nm or more and 200 nm or less, more preferably 60 nm or more and 150 nm or less, and still more preferably 70 nm or more and 130 nm or less.

In particular, the best way is to apply the coating composition to a film uniaxially stretched in the length direction (film B), stretch it in the width direction, and then heat-treat it. This is because as compared with the method involving biaxial stretching after coating an unstretched film, only one stretching step is required and accordingly, the resin layer (X) will suffer less numbers of defects and cracks attributable to stretching. Thus, the resulting resin layer (X) will be high in transparency and smoothness.

For off-line coating, on the other hand, film A described above is stretched uniaxially or biaxially, and heat-treated to complete the crystal orientation in the polyester film, and then coated with the coating composition, or coating of film A is performed in a separate step from the film production process.

For the present invention, it is preferable to use the in-line coating technique to form the resin layer (X) because of the various advantages given above.

To form the resin layer (X) according to the present invention, therefore, it is preferable that an aqueous coating composition based on an aqueous solvent (g) be applied to a polyester film by the in-line coating technique, followed by drying. More preferably, the coating composition is applied to film B, which is uniaxially stretched, by in-line coating. Furthermore, the solid content of the coating composition is preferably 5 wt % or less. A solid content of 5 wt % or less allows the coating composition to be high in coatability, making it possible to produce a laminated polyester film provided with a transparent, uniform resin layer.

### (8) Preparation Method for a Coating Composition Based on an Aqueous Solvent (g)

A coating composition based on an aqueous solvent (g) can be prepared by mixing an acrylic-urethane copolymer resin (a), which may be water-dispersed or water-soluble as required, polyester resin (b), isocyanate compound (c), carbodiimide compound (d), oxazoline compound (e) in an aqueous form, and aqueous solvent (g), which may be added in any appropriate order to give a mixture at a required solid content ratio by weight, followed by stirring.

Then, a melamine compound (f) is added as required to the coating composition in any appropriate order to give a mixture at a required solid content ratio by weight, followed by stirring, thereby completing the production.

The mixing and stirring can be achieved by shaking the container by hand, using a magnetic stirrer, stirring blade, etc., performing ultrasonic irradiation, vibration dispersion, etc.

If necessary, various additives including lubricant, inorganic particles, organic particles, surface active agent, and antioxidant may be added to such an extent that the characteristics of the resin layer formed from the coating composition will not be deteriorated.

### (9) Coating Method

To coat the polyester film with the coating composition, a generally known coating method such as, for example, bar coating, reverse coating, gravure coating, die coating, and blade coated may be adopted appropriately.

### (10) Production Method for Laminated Polyester Film

Described next is a production method for the laminated polyester film according to the present invention using, as an example, polyethylene terephthalate (hereinafter abbreviated as PET) film as the polyester base, but as a matter of course, the present invention should not be construed as limited thereto. First, pellets of PET are vacuum-dried adequately, supplied to an extruder, melt-extruded at about 280° C. into a sheet, and cooled for solidification to prepare an unstretched (unoriented) PET film (film A). This film is stretched 2.5 to 5.0 times in the length direction between rolls heated at 80 to 120° C. to provide a uniaxially oriented PET film (film B). The coating composition according to the present invention adjusted to a predetermined concentration is applied to one side of this film B. In this instance, the surface of the PET film to be coated may be subjected to surface treatment such as corona discharge treatment before coating. The implementation of surface treatment such as corona discharge treatment can improve the wettability of the PET film with the coating composition and prevents the cissing of the coating composition to ensure a uniform coating thickness.

After the coating, the PET film, with its ends clipped, is introduced into a heat treatment zone (preheat zone) adjusted to 80° C. to 130° C. to remove the solvent from the coating composition. After drying, it is stretched 1.1 to 5.0 times in the width direction. Subsequently, it is introduced into another heat treatment zone (heat set zone) adjusted to 160° C. to 240° C. where it is heat-treated for 1 to 30 seconds to complete crystal orientation.

In this heat treatment step (heat set step), the film may be relaxed by 3 to 15% in the width direction or in the length direction as required. The laminated polyester film thus obtained must be a laminated polyester film that is high in transparency, adhesiveness to a hard coat layer, wet-heat-resistant adhesiveness, UV-resistant adhesiveness, boiling-resistant adhesiveness, boiling-resistant transparency, and visibility after lamination with a hard coat layer.

### [Methods for Measurement of Characteristics and Methods for Evaluation of Effects]

### (1) Evaluation Method for Transparency

The transparency was evaluated based on initial haze (%). For haze determination, a specimen of a laminated polyester film was left to stand under normal conditions (temperature 23° C., relative humidity 65%) for one hour and subjected to measurement with a turbidity meter (NDH5000, manufactured by Nippon Denshoku Industries Co., Ltd.). Three measurements were made and their average was taken to represent the haze of the laminated polyester film. Its transparency was evaluated according to four-stage criteria for haze. A film ranked as C or B was judged to be practically inferior or practically fair, respectively. A film ranked as S or A was judged to be good.

S: less than 1.0%
A: 1.0% or more and less than 2.0%
B: 2.0% or more and less than 3.0%
C: 3.0% or more

### (2) Evaluation Methods for Adhesiveness to a Hard Coat Layer

### (2-1) Evaluation Method for Initial Adhesiveness

A UV curable resin mixed at a ratio as described below was applied uniformly with a bar coater over the surface of the resin layer (X) of a laminated polyester film in such a manner that the UV curable resin layer would have a film thickness of 2 μm after being cured.
dipentaerythritol hexaacrylate: 60 parts by weight
   (Kayarad (registered trademark) DPHA, manufactured by Nippon Kayaku Co., Ltd.)
pentaerythritol triacrylate: 40 parts by weight
   (Kayarad (registered trademark) PETA, manufactured by Nippon Kayaku Co., Ltd.)
photopolymerization initiator (Irgacure (registered trademark) 184, manufactured by Nagase & Co., Ltd.): 3 parts by weight
methyl ethyl ketone: 100 parts by weight

Subsequently, using a concentrating type high pressure mercury lamp (H03-L31, Eye Graphics Co., Ltd.) with an irradiation intensity of 120 W/cm set at a height of 9 cm above the surface of the UV curable resin layer, it was exposed to a total ultraviolet irradiation of 300 mJ/cm² and cured to provide a hard-coated laminated polyester film composed of a laminated polyester film laminated with a hard coat layer. A right-angle lattice pattern containing one hundred 1 mm² squares was cut into the hard coat surface of the resulting hard-coated laminated polyester film and Cellotape (registered trademark) (CT405AP, manufactured by Nichiban Co., Ltd.) was pasted. Then, a load of 1.5 kg/cm² was applied by pressing with a hand roller and the tape was peeled by pulling it perpendicular to the hard-coated laminated polyester film. The adhesiveness was evaluated according to four-stage criteria based on the number of remaining squares. A film ranked as C or B was judged to be practically inferior or practically fair, respectively. A film ranked as S or A was judged to be good.

S: 100 squares remaining
A: 80 to 99 squares remaining
B: 50 to 79 squares remaining
C: 0 to less than 50 squares remaining

### (2-2) Evaluation Method for Moist Heat Adhesiveness

A hard-coated laminated polyester film was prepared by the same procedure as for (2-1). The resulting hard-coated laminated polyester film was left to stand for 240 hours in a constant temperature and humidity tank with a humidity of 85° C. and relative humidity of 85%, followed by drying for one hour under normal conditions (23° C., relative humidity of 65%) to prepare a hard-coated laminated sample for wet heat test. The resulting hard-coated laminated sample for wet heat test was subjected to adhesiveness evaluation according to four-stage criteria by the same procedure as for (2-1). A film ranked as C or B was judged to be practically inferior or practically fair, respectively. A film ranked as S or A was judged to be good.

### (2-3) Evaluation Method for Boiling-Resistant Adhesiveness

The above UV curable resin was applied over the resin layer surface of a laminated polyester film by the same procedure as for evaluation (2-1) and cured to prepare a sample for boiling-resistant adhesiveness evaluation. Then, a part with a size of 10 cm×10 cm was cut out of the boiling-resistant adhesiveness evaluation sample, attached to and hung from a clip, and immersed for 18 hours in a boiling pure water (100° C.) in a beaker in such a manner that the entire surface of the laminated polyester film same was in the water. Subsequently, the sample for boiling-resistant adhesiveness evaluation was taken out and dried for one hour under normal conditions (23° C., relative humidity 65%) to provide a hard-coated laminated sample for boiling-resistant adhesiveness test. The resulting hard-coated laminated sample for boiling-resistant adhesiveness test was subjected to adhesiveness evaluation according to four-stage criteria by the same procedure as for (2-1). A film ranked as C or B was judged to be practically inferior or practically fair, respectively. A film ranked as S or A was judged to be good.

### (2-4) Evaluation Method for UV-Resistant Adhesiveness

The UV curable resin was applied over the surface of the resin layer (X) of a laminated polyester film by the same procedure as for evaluation (2-1) and cured to prepare a sample for UV-resistant adhesiveness test. Subsequently, it was exposed to ultraviolet rays to a total irradiation of 500 mJ/cm² by the same procedure as for (2-1), and this was repeated three times to achieve a total irradiation of 1,500 mJ/cm². The resulting hard-coated laminated sample for UV-resistant adhesiveness test was subjected to adhesiveness evaluation according to four-stage criteria by the same procedure as for (2-1). A film ranked as C or B was judged to be practically inferior or practically fair, respectively. A film ranked as S or A was judged to be good.

### (3) Evaluation Method for Visibility (Interference Pattern)

The same procedure as for (2-1) was carried out to prepare a hard-coated film composed of a laminated polyester film laminated with a hard coat layer with a thickness of 2 μm. Then, a specimen with a size of 8 cm (in the width direction of the hard coat film)×10 cm (in the length direction of the hard coat film) was cut out of the resulting hard coat film, and a black glossy tape (Vinyl Tape No. 200-50-21, black, supplied by Yamato Co., Ltd.) was pasted to the opposite surface of the hard coat layer in such a manner that bubbles would not form.

This specimen was placed 30 cm directly below a three band fluorescent lamp (three band type neutral white (F•L 15EX-N 15W), manufactured by Matsushita Electric Industrial Co., Ltd.) in a darkroom and the degree of interference fringes was observed visually from different viewing angles and evaluated as described below. A specimen ranked as A or higher was judged to be good.

S: Substantially no interference fringe is visible.
A: Interference fringes are slightly visible.
B: Weak interference fringes are visible.
C: Strong interference fringes are visible.

### (4) Evaluation Method for Thickness of Resin Layer (X)

The thickness of the resin layer (X) in the laminated polyester film was measured by observing its cross section by transmission electron microscopy (TEM). To determine the thickness of the resin layer (X), the thickness of the resin layer was observed in an image photographed by TEM at a magnification of 200,000×. The thickness was measured at 20 positions of the resin layer and their average was taken to represent the thickness (nm) of the resin layer (X).
Measuring apparatus: a transmission electron microscope (H-7100FA manufactured by Hitachi, Ltd.)

### (5) Evaluation Method for Reflectance

A film sheet cut to A4 size was trisected in the longitudinal and transverse directions to provide a total of nine samples for measurement. The direction of the longer sides was defined as length direction. For measurement of spectral reflectance, a black glossy tape with a width of 50 mm (Vinyl Tape No. 200-50-21, black, manufactured by Yamato Co., Ltd.) was pasted to the surface opposite to the measuring surface (resin layer (X)) of a sample in such a manner that their length directions coincided and that bubbles would not be caught, and then an about 4 cm×4 cm specimen was cut out and subjected to spectral reflectance measurement at an incidence angle of 5° using a spectrophotometer (UV2450, manufactured by Shimadzu Corporation). The specimen was mounted on the measuring apparatus in such a manner that the length direction of the specimen coincided with the front-to-rear direction when looked from in front of the apparatus. An accessory Al₂O₃ plate was used as reference reflector to normalize the measured reflectance. For the reflectance determination, the reflectance of light with a wavelength 550 nm on the resin layer (X) was measured. A total of 10 measurements were made and their average was used.

### (6) Evaluation Method for Dispersion Index (Based on Transmission Electron Microscopic (TEM) Cross-Sectional Photographs)

A surface specimen of the resin layer (X) of a laminated polyester film is prepared by RuO₄-dyeing ultramicrotomy. The cross section of the resulting specimen was observed by transmission electron microscopy (TEM) and cross-section photographs were obtained under the conditions described below. In a cross-sectional photograph, an area with a size of 1,200 nm×500 nm in the field of view was observed, and the number of aggregates measuring 40 nm or more and containing acrylic-urethane copolymerization resin (a) was counted. This observation was performed for 10 areas and the average number of aggregates existing per area (1,200 nm×500 nm) was rounded off to the whole number to give the dispersion index.
Measuring apparatus: a transmission electron microscope (H-7100FA manufactured by Hitachi, Ltd.)
Measuring conditions: accelerating voltage: 100 kV
Magnification: 20,000

### (7) Evaluation Method for Boiling-Resistant Transparency

Evaluation of boiling-resistant transparency was performed based on the change in haze (ΔHz) (%) between before and after immersion of a laminated polyester film in boiling water. A piece with a size of 10 cm×10 cm was cut out of a laminated polyester film, attached to and hung from a clip, and immersed for one hour in a boiling pure water (100° C.) in a beaker in such a manner that the entire surface of the laminated polyester film same was in the water. Subsequently, the laminated polyester film was taken out and dried for 5 hours under normal conditions (23° C., relative humidity 65%) to provide a specimen for boiling-resistant transparency test. In the case of a sample having the resin layer (X) on only one side of a polyester film, the surface of the polyester film opposite to the one provided with the resin layer was wiped with nonwoven fabric (Haize Gauze NT-4, manufactured by Ozu Corporation) containing acetone and then dried by leaving it to stand for one hour under normal conditions, thereby removing the oligomers coming out of the polyester film through the surface opposite to the one with the resin layer.

The resulting sample for boiling-resistant transparency test was subjected to transparency evaluation by the same procedure as for (1) and the value obtained was adopted to represent the haze (%) after boiling test. The haze (%) before boiling test (that is, initial haze) was subtracted from this value to give the change in haze ΔHz between before and after boiling test (ΔHz=haze after boiling test−haze before boiling test), which was used for evaluation of boiling-resistant transparency according to four-stage criteria.

A film ranked as C or B was judged to be practically inferior or practically fair, respectively. A film ranked as S or A was judged to be good.

S: less than 1.5%
A: 1.5% or more and less than 3.0%
B: 3.0% or more and less than 4.5%
C: 4.5% or more

### EXAMPLES

The invention is described more specifically below with reference to examples. It should be noted that the present invention should not be construed as limited to the examples given below. Acrylic-urethane copolymer resin and polyester resin with a naphthalene skeleton were synthesized by the procedures described in the reference examples given below.

### Reference Example 1

### Preparation of an Aqueous Dispersion of Acrylic-Urethane Copolymer Resin (a-1)

In a nitrogen gas atmosphere at room temperature (25° C.), 66 parts by weight of polyester based urethane resin (Hydran (registered trademark) AP-40(F), manufactured by DIC), 35 parts by weight of methyl methacrylate, 29 parts by weight of ethyl acrylate, and 2 parts by weight of N-methylol acrylamide were put in a container 1 to provide a solution 1. Then, 7 parts by weight of an emulsifier (Reasoap ER-30, manufactured by Adeka Corporation) was added and further, water was added to adjust the solid content of the solution to 50 wt % to provide a solution 2. To the container 2, 30 parts by weight of water was added at room temperature (25° C.) and it was heated up to 60° C. Subsequently, the solution 2 was dropped little by little continuously to the container 2 while stirring in such a manner that the dropping would end in 3 hours. At the same time, 3 parts by weight of a 5 wt % aqueous potassium persulfate solution was also dropped continuously to the container 2. After the end of the dropping, the solution was stirred additionally for 2 hours and cooled to 25° C. to complete the reaction, thereby providing an aqueous dispersion of acrylic-urethane copolymer resin (a-1). Here, the resulting aqueous dispersion of acrylic-urethane copolymer resin (a-1) had a solid content of 30 wt %.

In Reference examples 2 to 13 given below, the quantities of dicarboxylic acid components and diol components are shown as proportions relative to the total quantity, or 100 mol %, of all dicarboxylic acid components and all diol components. The molar ratio between all dicarboxylic acid components and all diol components is 1:1 in Reference examples 2 to 13.

### Reference Example 2

### Preparation of Aqueous Dispersion of Polyester Resin with a Naphthalene Skeleton (b-1)

An aqueous dispersion of polyester resin composed of the copolymerization components given below.

### <Copolymerization Components>

### (Dicarboxylic Acid Components)

2,6-dimethyl naphthalene dicarboxylate: 88 mol %
5-sodium sulfodimethyl isophthalate: 12 mol %

### (Diol Components)

a compound produced by adding 2 moles of ethylene oxide to 1 mole of bisphenol S 86 mol %
1,3-propanediol: 14 mol %

### Reference Example 3

### Preparation of an Aqueous Dispersion Polyester Resin (b-2) Having a Naphthalene Skeleton and Having an Aromatic Dicarboxylic Acid Component Containing a Metal Sulfonate Group

An aqueous dispersion of polyester resin composed of the copolymerization components given below.

### <Copolymerization Components>

### (Dicarboxylic Acid Components)

2,6-dimethyl naphthalene dicarboxylate: 99 mol %
5-sodium sulfodimethyl isophthalate: 1 mol %

### (Diol Components)

a compound produced by adding 2 moles of ethylene oxide to 1 mole of bisphenol S 86 mol %
1,3-propanediol: 14 mol %

### Reference Example 4

### Preparation of an Aqueous Dispersion Polyester Resin (b-3) Having a Naphthalene Skeleton and Having an Aromatic Dicarboxylic Acid Component Containing a Metal Sulfonate Group

An aqueous dispersion of polyester resin composed of the copolymerization components given below.

### <Copolymerization Components>

### (Dicarboxylic Acid Components)

2,6-dimethyl naphthalene dicarboxylate: 85 mol %
5-sodium sulfodimethyl isophthalate: 15 mol %

### (Diol Components)

a compound produced by adding 2 moles of ethylene oxide to 1 mole of bisphenol S 86 mol %
1,3-propanediol: 14 mol %

### Reference Example 5

### Preparation of an Aqueous Dispersion Polyester Resin (b-4) Having a Naphthalene Skeleton and Having an Aromatic Dicarboxylic Acid Component Containing a Metal Sulfonate Group

An aqueous dispersion of polyester resin composed of the copolymerization components given below.

### <Copolymerization Components>

### (Dicarboxylic Acid Components)

2,6-naphthalene dicarboxylic acid: 85 mol %
5-sodium sulfodimethyl isophthalate: 15 mol %

### (Diol Components)

a compound produced by adding 2 moles of ethylene oxide to 1 mole of bisphenol S 86 mol %
1,3-propanediol: 14 mol %

### Reference Example 6

### Preparation of an Aqueous Dispersion Polyester Resin (b-5) Having a Naphthalene Skeleton and Having an Aromatic Dicarboxylic Acid Component Containing a Metal Sulfonate Group

An aqueous dispersion of polyester resin composed of the copolymerization components given below.

### <Copolymerization Components>

### (Dicarboxylic Acid Components)

2,6-dimethyl naphthalene dicarboxylate: 65 mol %
5-sodium sulfodimethyl isophthalate: 35 mol %

### (Diol Components)

a compound produced by adding 2 moles of ethylene oxide to 1 mole of bisphenol S 86 mol %
1,8-octanediol: 14 mol %

### Reference Example 7

### Preparation of an Aqueous Dispersion Polyester Resin (b-6) Having a Naphthalene Skeleton and not Having an Aromatic Dicarboxylic Acid Component Containing a Metal Sulfonate Group

An aqueous dispersion of polyester resin composed of the copolymerization components given below.

### <Copolymerization Components>

### (Dicarboxylic Acid Components)

2,6-dimethyl naphthalene dicarboxylate: 88 mol %
trimellitic acid: 12 mol %

### (Diol Components)

a compound produced by adding 2 moles of ethylene oxide to 1 mole of bisphenol S 86 mol %
ethylene glycol: 14 mol %

### Reference Example 8

### Preparation of an Aqueous Dispersion of Polyester Resin (b-7) Having a Naphthalene Skeleton and Additionally Having a Bisphenol S Skeleton

An aqueous dispersion of polyester resin composed of the copolymerization components given below.

### <Copolymerization Components>

### (Dicarboxylic Acid Components)

2,6-dimethyl naphthalene dicarboxylate: 88 mol %
5-sodium sulfodimethyl isophthalate: 12 mol %

### (Diol Components)

a compound produced by adding 2 moles of propylene oxide to 1 mole of bisphenol S 86 mol %
ethylene glycol: 14 mol %

### Reference Example 9

### Preparation of an Aqueous Dispersion of Ester Resin (b-8) Having a Naphthalene Skeleton and Additionally Having a Bisphenol S Skeleton

An aqueous dispersion of polyester resin composed of the copolymerization components given below.

### <Copolymerization Components>

### (Dicarboxylic Acid Components)

2,6-dimethyl naphthalene dicarboxylate: 88 mol %
5-sodium sulfodimethyl isophthalate: 12 mol %

### (Diol Components)

a compound produced by adding 10 moles of propylene oxide to 1 mole of bisphenol S 50 mol %
ethylene glycol: 50 mol %

### Reference Example 10

### Preparation of an Aqueous Dispersion of Polyester Resin (b-9) Having a Naphthalene Skeleton and Additionally Having a Bisphenol A Skeleton

An aqueous dispersion of polyester resin composed of the copolymerization components given below.

### <Copolymerization Components>

### (Dicarboxylic Acid Components)

2,6-dimethyl naphthalene dicarboxylate: 85 mol %
5-lithium sulfodimethyl isophthalate: 15 mol %

### (Diol Components)

a compound produced by adding 2 moles of ethylene oxide to 1 mole of bisphenol A 86 mol %
ethylene glycol: 14 mol %

### Reference Example 11

### Preparation of an Aqueous Dispersion of Polyester Resin (b-10) Having a Naphthalene Skeleton and Having a Bisphenol A Skeleton

An aqueous dispersion of polyester resin composed of the copolymerization components given below.

### <Copolymerization Components>

### (Dicarboxylic Acid Components)

2,6-dimethyl naphthalene dicarboxylate: 85 mol %
5-sodium sulfodimethyl isophthalate: 15 mol %

### (Diol Components)

a compound produced by adding 10 moles of propylene oxide to 1 mole of bisphenol A 86 mol %
ethylene glycol: 14 mol %

### Reference Example 12

### Preparation of Aqueous Dispersion of Polyester Resin (b-11) not Having a Naphthalene Skeleton

An aqueous dispersion of polyester resin composed of the copolymerization components given below.

### <Copolymerization Components>

### (Dicarboxylic Acid Components)

isophthalic acid: 88 mol %
5-sodium sulfodimethyl isophthalate: 12 mol %

### (Diol Components)

a compound produced by adding 2 moles of ethylene oxide to 1 mole of bisphenol S 86 mol %
ethylene glycol: 14 mol %

### Reference Example 13

### Preparation of Aqueous Dispersion of Polyester Resin (b-12) not Having a Naphthalene Skeleton

An aqueous dispersion of polyester resin composed of the copolymerization components given below.

### <Copolymerization Components>

### (Dicarboxylic Acid Components)

terephthalic acid: 88 mol %
5-sodium sulfodimethyl isophthalate: 12 mol %

### (Diol Components)

a compound produced by adding 2 moles of ethylene oxide to 1 mole of bisphenol S 86 mol %
ethylene glycol: 14 mol %

### Example 1

A coating composition was prepared as described below.

an aqueous dispersion of acrylic-urethane copolymer resin (a): Sannalon WG-658 (solid content 30 wt %) manufactured by Sannan Chemical Industry Co., Ltd.
an aqueous dispersion of polyester resin (b): polyester resin (b-1) (solid content 15 wt %)
an aqueous dispersion of isocyanate compound (c): Elastron (registered trademark) E-37 (solid content 28 wt %) manufactured by Dai-Ichi Kogyo Seiyaku Co., Ltd.
an aqueous dispersion of oxazoline compound (d): Epocros (registered trademark) WS-500 (solid content 40 wt %) manufactured by Nippon Shokubai Co., Ltd.
an aqueous dispersion of carbodiimide compound (e): Carbodilite (registered trademark) V-04 (solid content 40 wt %) manufactured by Nisshinbo Industries, Inc.
aqueous solvent (G): pure water

The components (a) to (e) described above were mixed in such a manner that the solid content ratio by weight of (a)/(b)/(c)/(d)/(e) was 15/85/10/30/30 and the component (g) was added to adjust the solid content of the coating composition to 8.5 wt %. The contents of resin components in the coating composition are shown in Table 1-1.

Subsequently, PET pellets (with an intrinsic viscosity of 0.63 dl/g) substantially free of particles were vacuum-dried sufficiently, supplied to an extruder, melted at 285° C., and extruded through a T-die to produce a sheet, which was cooled for solidification by bringing it into contact, by the electrostatic casting technique, with a mirror-finished casting drum with a surface temperature 25° C. The resulting unstretched film was heated up to 90° C. and stretched 3.4 times in the length direction to provide a uniaxialy stretched film (film B). This film was subjected to corona discharge treatment in air.

Then, the coating composition with a concentration adjusted with an aqueous solvent was applied with a bar coater to the corona discharge treated surface of the uniaxially stretched film. The uniaxially stretched film coated with the coating composition having a concentration adjusted with an aqueous solvent was introduced into the preheat zone, with its width-directional ends attached to clips, and the temperature in the zone was adjusted to 75° C. Subsequently, the temperature was raised to 110° C. by a radiation heater and then the temperature was lowered to 90° C. to dry the coating composition having a concentration adjusted with an aqueous solvent, thereby forming a resin layer (X). Subsequently, it was stretched 3.5 times in the width direction in the heating zone (stretching zone) at 120° C. and heat-treated for 20 seconds in the heat treatment zone (heat set zone) at 230° C. to provide a crystal-oriented laminated polyester film. In the resulting laminated polyester film, the PET film had a thickness of 100 μm.

Characteristics etc. of the resulting laminated polyester film are shown in Table 2-1. The film had a low haze and high transparency and it was very high in initial adhesiveness with a hard coat layer and wet-heat-resistant adhesiveness and also high in UV-resistant adhesiveness, boiling-resistant adhesiveness, boiling-resistant transparency, and visibility.

### Examples 2 to 3

Except for using the melamine compound (f) shown below and adding the component (f) to a solid content given in Table 1-1, the same procedure as in Example 1 was carried out to produce a laminated polyester film. Characteristics etc. of the resulting laminated polyester film are shown in Table 2-1. As compared with Example 1, the film, which contained a melamine compound, was higher in boiling-resistant adhesiveness, UV-resistant adhesiveness, and boiling-resistant transparency, in addition to being comparable in transparency, initial adhesiveness, wet-heat-resistant adhesiveness, and visibility.

aqueous dispersion of melamine compound (f): Nikalac (registered trademark) MW12LF manufactured by Sanwa Chemical Co., Ltd.
(solid content: 71 wt %)

### Example 4

Except for adding the melamine compound (f) to a solid content given in Table 1-1, the same procedure as in Example 3 was carried out to produce a laminated polyester film. Characteristics etc. of the resulting laminated polyester film are shown in Table 2-1. As compared with Example 3, the film, which had an increased content of the melamine compound (f), had a slightly higher initial haze and slightly larger dispersion index and it was sufficiently high, though slightly lower, in transparency, boiling-resistant adhesiveness, UV-resistant adhesiveness, and boiling-resistant transparency, and comparable in initial adhesiveness, wet-heat-resistant adhesiveness, and visibility.

### Example 5

Except for using the polyester resin (b-2) as polyester compound (b), the same procedure as in Example 3 was carried out to produce a laminated polyester film. Characteristics etc. of the resulting laminated polyester film are shown in Table 2-1.

As compared with Example 3, the film, which contained the polyester resin (b-2) that had a smaller content of an aromatic dicarboxylic acid component containing a metal sulfonate group, had a slightly higher initial haze and slightly larger dispersion index and it was sufficiently high, though slightly lower, in transparency, boiling-resistant adhesiveness, UV-resistant adhesiveness, and boiling-resistant transparency, and comparable in initial adhesiveness, wet-heat-resistant adhesiveness, and visibility.

### Examples 6 to 7

Except for using the polyester resin (b-3) (Example 6) or the polyester resin (b-4) (Example 7) as polyester compound (b), the same procedure as in Example 3 was carried out to produce a laminated polyester film. Characteristics etc. of the resulting laminated polyester film are shown in Table 2-1. As compared with Example 3, the film, which contained a polyester resin that had a larger content of an aromatic dicarboxylic acid component containing a metal sulfonate group, had a slightly lower initial haze and slightly smaller dispersion index and it was comparably high in initial adhesiveness, wet-heat-resistant adhesiveness, boiling-resistant adhesiveness, UV-resistant adhesiveness, boiling-resistant transparency, and visibility.

### Example 8

Except for using the polyester resin (b-5) as polyester compound (b), the same procedure as in Example 3 was carried out to produce a laminated polyester film. Characteristics etc. of the resulting laminated polyester film are shown in Table 2-1. As compared with Example 3, the film, which contained a polyester resin that had a larger content of an aromatic dicarboxylic acid component containing a metal sulfonate group, had a slightly higher initial haze and slightly larger dispersion index and it was sufficiently high, though slightly lower, in transparency, visibility, initial adhesiveness, boiling-resistant adhesiveness, UV-resistant adhesiveness, and boiling-resistant transparency.

### Example 9

Except for using the polyester resin (b-6) as polyester compound (b), the same procedure as in Example 3 was carried out to produce a laminated polyester film. Characteristics etc. of the resulting laminated polyester film are shown in Table 2-1. As compared with Example 3, the film, which contained a polyester resin that was free of an aromatic dicarboxylic acid component containing a metal sulfonate group, had a slightly higher initial haze and slightly larger dispersion index and it was sufficiently high, though slightly lower, in transparency, visibility, initial adhesiveness, boiling-resistant adhesiveness, UV-resistant adhesiveness, and boiling-resistant transparency.

### Examples 10 to 11

Except for using the polyester resin (b-7) (Example 10) or the polyester resin (b-8) (Example 11) as polyester compound (b), the same procedure as in Example 3 was carried out to produce a laminated polyester film.

Characteristics etc. of the resulting laminated polyester film are shown in Table 2-1. As compared with Example 3, the films, which differed in the type of polyester resin with a bisphenol S skeleton, were comparably high in initial adhesiveness, wet-heat-resistant adhesiveness, UV-resistant adhesiveness, boiling-resistant adhesiveness, boiling-resistant transparency, and visibility.

### Example 12

Except for adding the isocyanate compound (c) to a solid content given in Table, the same procedure as in Example 3 was carried out to produce a laminated polyester film. Characteristics etc. of the resulting laminated polyester film are shown in Table 2-1. As compared with Example 3, the film, which had a decreased content of the isocyanate compound (c), was slightly lower in initial adhesiveness, wet-heat-resistant adhesiveness, boiling-resistant adhesiveness, UV-resistant adhesiveness, and boiling-resistant transparency, but comparable in transparency and visibility.

### Examples 13 to 14

Except for adding the isocyanate compound (c) to a solid content given in Table, the same procedure as in Example 1 was carried out to produce a laminated polyester film. Characteristics etc. of the resulting laminated polyester film are shown in Table 2-1. As compared with Example 3, the films, which had an increased content of the isocyanate compound (c), were comparable in transparency and higher in initial adhesiveness, wet-heat-resistant adhesiveness, boiling-resistant adhesiveness, UV-resistant adhesiveness, boiling-resistant transparency, and visibility.

### Examples 15 to 16

Except for adding the carbodiimide compound (d) to a solid content given in Table, the same procedure as in Example 1 was carried out to produce a laminated polyester film. Characteristics etc. of the resulting laminated polyester film are shown in Table 2-1. As compared with Example 3, the film, which had a decreased content of the carbodiimide compound (d), was sufficiently high, though slightly lower, in initial adhesiveness, wet-heat-resistant adhesiveness, boiling-resistant adhesiveness, UV-resistant adhesiveness, and boiling-resistant transparency, and comparable in transparency and visibility.

### Example 17

Except for adding the carbodiimide compound (d) to a solid content given in Table 1-1, the same procedure as in Example 3 was carried out to produce a laminated polyester film. Characteristics etc. of the resulting laminated polyester film are shown in Table.

As compared with Example 3, the film, which had an increased content of the carbodiimide compound (d), was comparably high in transparency, initial adhesiveness, wet-heat-resistant adhesiveness, boiling-resistant adhesiveness, UV-resistant adhesiveness, boiling-resistant transparency, and visibility.

### Examples 18 to 19

Except for adding the oxazoline compound (e) to a solid content given in Table 1-2, the same procedures as in Example 3 were carried out to produce laminated polyester films. Characteristics etc. of the resulting laminated polyester film are shown in Table 2-2. As compared with Example 3, the films, which had a decreased content of the oxazoline compound (e), were sufficiently high, though slightly lower, in initial adhesiveness, wet-heat-resistant adhesiveness, boiling-resistant adhesiveness, UV-resistant adhesiveness, and boiling-resistant transparency, and comparable in transparency and visibility.

### Example 20

Except for adding the oxazoline compound (e) to a solid content given in Table 1-2, the same procedure as in Example 3 was carried out to produce a laminated polyester film. Characteristics etc. of the resulting laminated polyester film are shown in Table 2-2. As compared with Example 3, the film, which had an increased content of the oxazoline compound (e), was comparable in transparency and higher in initial adhesiveness, wet-heat-resistant adhesiveness, boiling-resistant adhesiveness, UV-resistant adhesiveness, boiling-resistant transparency, and visibility.

### Examples 21 to 22

Except for changing the solid content ratio by weight between the acrylic-urethane copolymer resin (a) and the polyester resin (b) as shown in Table 1-2, the same procedures as in Example 3 were carried out to produce laminated polyester films. Characteristics etc. of the resulting laminated polyester films are shown in Table 2-2. As compared with Example 3, as a result of changing the ratio as acrylic-urethane copolymer resin (a)/polyester resin (b)=40/60 (Example 21) or acrylic-urethane copolymer resin (a)/polyester resin (b)=30/70 (Example 22), the films were slightly higher in dispersion index, slightly lower in reflectance, and slightly higher in haze, but higher in transparency. In addition, the films were sufficiently high, though slightly lower, in boiling-resistant adhesiveness, UV-resistant adhesiveness, boiling-resistant transparency, and visibility, and comparable in initial adhesiveness and wet-heat-resistant adhesiveness.

### Example 23

Except for changing the solid content ratio by weight between the acrylic-urethane copolymer resin (a) and the polyester resin (b) as shown in Table 1-2, the same procedure as in Example 3 was carried out to produce a laminated polyester film. Characteristics etc. of the resulting laminated polyester film are shown in Table 2-2. As compared with Example 3, although the ratio acrylic-urethane copolymer resin (a)/polyester resin (b) was 20/80, the film was comparable in transparency and higher in initial adhesiveness, wet-heat-resistant adhesiveness, boiling-resistant adhesiveness, UV-resistant adhesiveness, boiling-resistant transparency, and visibility.

### Example 24

Except for changing the solid content ratio by weight between the acrylic-urethane copolymer resin (a) and the polyester resin (b) as shown in Table 1-2, the same procedure as in Example 3 was carried out to produce a laminated polyester film. Characteristics etc. of the resulting laminated polyester film are shown in Table 2-2. As compared with Example 3, as a result of the ratio of acrylic-urethane copolymer resin (a)/polyester resin (b) being 5/95, the film was slightly lower in dispersion index, slightly lower in haze, slightly higher in reflectance, and higher in transparency. Furthermore, the film was sufficiently high, though slightly lower, in initial adhesiveness, wet-heat-resistant adhesiveness, boiling-resistant adhesiveness, UV-resistant adhesiveness, boiling-resistant transparency, and visibility.

### Example 25

Except for adding the isocyanate compound (c) to a solid content given in Table 1-2, the same procedure as in Example 3 was carried out to produce a laminated polyester film. Characteristics etc. of the resulting laminated polyester film are shown in Table 2-2.

As compared with Example 3, the film, which had a decreased content of the isocyanate compound (c), was high in visibility and transparency, and sufficiently high, though slightly lower, in initial adhesiveness, wet-heat-resistant adhesiveness, boiling-resistant adhesiveness, UV-resistant adhesiveness, and boiling-resistant transparency.

### Example 26

Except for adding the isocyanate compound (c) to a solid content given in Table 1-2, the same procedure as in Example 3 was carried out to produce a laminated polyester film. Characteristics etc. of the resulting laminated polyester film are shown in Table 2-2.

As compared with Example 3, the film, which had an increased content of the isocyanate compound (c), was slightly higher in haze and slightly lower in transparency, but still sufficiently good in these properties. In addition, the film was comparable in initial adhesiveness, wet-heat-resistant adhesiveness, boiling-resistant adhesiveness, UV-resistant adhesiveness, and boiling-resistant transparency.

### Example 27

Except for adding the carbodiimide compound (d) to a solid content given in Table 1-2, the same procedure as in Example 3 was carried out to produce a laminated polyester film. Characteristics etc. of the resulting laminated polyester film are shown in Table 2-2.

As compared with Example 3, the film, which had a decreased content of the carbodiimide compound (d), was sufficiently high, though slightly lower, in initial adhesiveness, wet-heat-resistant adhesiveness, boiling-resistant adhesiveness, UV-resistant adhesiveness, and boiling-resistant transparency.

### Example 28

Except for adding the carbodiimide compound (d) to a solid content given in Table 1-2, the same procedure as in Example 3 was carried out to produce a laminated polyester film. Characteristics etc. of the resulting laminated polyester film are shown in Table 2-2.

As compared with Example 3, the film, which had an increased content of the carbodiimide compound (d), was slightly higher in haze and slightly lower in transparency, but still sufficiently good in these properties. In addition, the film was comparable in initial adhesiveness, wet-heat-resistant adhesiveness, boiling-resistant adhesiveness, UV-resistant adhesiveness, and boiling-resistant transparency.

### Example 29

Except for adding the oxazoline compound (e) to a solid content given in Table 1-2, the same procedure as in Example 3 was carried out to produce a laminated polyester film. Characteristics etc. of the resulting laminated polyester film are shown in Table 2-2.

As compared with Example 3, the film, which had a decreased content of the oxazoline compound (e), was sufficiently high, though slightly lower, in initial adhesiveness, wet-heat-resistant adhesiveness, boiling-resistant adhesiveness, UV-resistant adhesiveness, and boiling-resistant transparency.

### Example 30

Except for adding the oxazoline compound (e) to a solid content given in Table 1-2, the same procedure as in Example 3 was carried out to produce a laminated polyester film. Characteristics etc. of the resulting laminated polyester film are shown in Table 2-2.

As compared with Example 3, the film, which had an increased content of the oxazoline compound (e), was slightly higher in haze and slightly lower in transparency, but still sufficiently good in these properties. In addition, the film was comparable in initial adhesiveness, wet-heat-resistant adhesiveness, boiling-resistant adhesiveness, UV-resistant adhesiveness, and boiling-resistant transparency.

### Example 31

Except for adding the melamine compound (f) to a solid content given in Table 1-2, the same procedure as in Example 3 was carried out to produce a laminated polyester film. Characteristics etc. of the resulting laminated polyester film are shown in Table 2-2.

As compared with Example 3, the film, which had a decreased content of the melamine compound (f), was comparably high in transparency, initial adhesiveness, and wet-heat-resistant adhesiveness. Furthermore, the film was sufficiently high, though slightly lower, in boiling-resistant adhesiveness, UV-resistant adhesiveness, and boiling-resistant transparency.

### Example 32

Except for adding the melamine compound (f) to a solid content given in Table 1-2, the same procedure as in Example 3 was carried out to produce a laminated polyester film. Characteristics etc. of the resulting laminated polyester film are shown in Table 2-2.

As compared with Example 3, the film, which had an increased content of the melamine compound (f), was slightly higher in dispersion index and haze, but sufficiently good in these properties. Furthermore, the film was sufficiently high, though slightly lower, in boiling-resistant adhesiveness, UV-resistant adhesiveness, and boiling-resistant transparency.

### Example 33

Except for using the polyester resin (b-9) as polyester compound (b), the same procedure as in Example 3 was carried out to produce a laminated polyester film.

Characteristics etc. of the resulting laminated polyester film are shown in Table 2-2. As compared with Example 3, the film, which contained polyester resin with a bisphenol A backbone, was slightly higher in initial haze and dispersion index and lower in reflectance, and accordingly slightly lower in transparency, visibility, boiling-resistant adhesiveness, UV-resistant adhesiveness, and boiling-resistant transparency, but comparably high in initial adhesiveness and wet-heat-resistant adhesiveness.

### Example 34

Except for using the polyester resin (b-10) as polyester compound (b), the same procedure as in Example 3 was carried out to produce a laminated polyester film.

Characteristics etc. of the resulting laminated polyester film are shown in Table 2-2. As compared with Example 3, the film, which contained polyester resin with a bisphenol A backbone, was slightly higher in initial haze and dispersion index and lower in reflectance, and accordingly slightly lower in transparency, visibility, boiling-resistant adhesiveness, UV-resistant adhesiveness, and boiling-resistant transparency, but comparably high in initial adhesiveness and wet-heat-resistant adhesiveness.

### Comparative Example 1

Except for adding the components (a) to (f) to solid contents given in Table 1-3, the same procedure as in Example 1 was carried out to produce a laminated polyester film. Characteristics etc. of the resulting laminated polyester film are shown in Table 2-3.

As compared with Example 1, the laminated polyester film prepared in Comparative example 1, which was free of acrylic-urethane copolymer resin, was comparably high in transparency, but inferior in performance in terms of initial adhesiveness, wet-heat-resistant adhesiveness, boiling-resistant adhesiveness, UV-resistant adhesiveness, boiling-resistant transparency, and visibility.

### Comparative Examples 2 and 3

Except for adding the components (a) to (f) to solid contents given in Table 1-3, the same procedures as in Example 3 were carried out to produce laminated polyester films. Characteristics etc. of the resulting laminated polyester films are shown in Table 2-3.

As compared with Example 3, the laminated polyester films prepared in Comparative examples 2 and 3, which were free of the polyester resin (b) with a naphthalene skeleton, were comparably high in transparency, initial adhesiveness, wet-heat-resistant adhesiveness, boiling-resistant adhesiveness, UV-resistant adhesiveness, and boiling-resistant transparency, but inferior in performance in terms of visibility.

### Comparative Examples 4 to 6

Except for adding the components (a) to (f) to solid contents given in Table, the same procedures as in Example 3 were carried out to produce laminated polyester films. Characteristics etc. of the resulting laminated polyester films are shown in Table 2-3.

As compared with Example 3, the laminated polyester film prepared in Comparative example 4, which was free of the isocyanate compound (c), was comparably high in transparency and higher in visibility, but inferior in performance in terms of wet-heat-resistant adhesiveness, boiling-resistant adhesiveness, UV-resistant adhesiveness, and boiling-resistant transparency.

As compared with Example 3, the laminated polyester film prepared in Comparative example 5, which was free of the carbodiimide compound (d), was comparably high in transparency and higher in visibility, but inferior in performance in terms of initial adhesiveness, wet-heat-resistant adhesiveness, boiling-resistant adhesiveness, UV-resistant adhesiveness, and boiling-resistant transparency.

As compared with Example 3, the laminated polyester film prepared in Comparative example 6, which was free of the oxazoline compound (e), was comparably high in transparency and higher in visibility, but inferior in performance in terms of initial adhesiveness, wet-heat-resistant adhesiveness, boiling-resistant adhesiveness, UV-resistant adhesiveness, and boiling-resistant transparency.

### Comparative Examples 7 to 10

Except for changing the solid content ratio by weight between the acrylic-urethane copolymer resin (a) and the polyester resin (b) as shown in Table, the same procedures as in Example 3 were carried out to produce laminated polyester films. Characteristics etc. of the resulting laminated polyester films are shown in Table 2-3.

As compared with Example 3, the laminated polyester film prepared in Comparative example 7, in which acrylic-urethane copolymer resin (a)/polyester resin (b)=50/50, had a higher dispersion index of 7, and it was slightly higher in haze and lower in reflectance. The film was comparably high in initial adhesiveness and wet-heat-resistant adhesiveness, but inferior in boiling-resistant adhesiveness, UV-resistant adhesiveness, boiling-resistant transparency, and visibility.

As compared with Example 3, the laminated polyester film prepared in Comparative example 8, in which acrylic-urethane copolymer resin (a)/polyester resin (b)=60/40, had a higher dispersion index of 10, and it was lower in reflectance, higher in haze, and lower in transparency. The film was comparable in initial adhesiveness and wet-heat-resistant adhesiveness, but inferior in boiling-resistant adhesiveness, UV-resistant adhesiveness, boiling-resistant transparency, and visibility.

As compared with Example 3, the laminated polyester film prepared in Comparative example 9, in which acrylic-urethane copolymer resin (a)/polyester resin (b)=80/20, had a higher dispersion index of 15, and it was lower in reflectance, higher in haze, and lower in transparency. The film was comparable in initial adhesiveness and wet-heat-resistant adhesiveness, but inferior in boiling-resistant adhesiveness, UV-resistant adhesiveness, boiling-resistant transparency, and visibility.

The laminated polyester film prepared in Comparative example 10, in which acrylic-urethane copolymer resin (a)/polyester resin (b)=90/10, had a higher dispersion index of 20, and it was lower in reflectance, higher in haze, and lower in transparency. The film was comparable in initial adhesiveness and wet-heat-resistant adhesiveness, but inferior in boiling-resistant adhesiveness, UV-resistant adhesiveness, boiling-resistant transparency, and visibility.

TABLE 1-1

| | Components of resin composition in coating composition | | | | | | |
|---|---|---|---|---|---|---|---|
| | Solid content ratio by weight among components of coating composition | | | | | | species of |
| | | polyester | | | | | polyester resin |
| | acrylic-urethane | resin with | isocyanate | carbodiimide | oxazoline | melamine | with naphthalene |
| | copolymer resin | naphthalene | compound | compound | compound | compound | skeleton |
| | (a) | skeleton (b) | (c) | (d) | (e) | (f) | (b) |
| Example 1 | 15 | 85 | 10 | 30 | 30 | — | b-1 |
| Example 2 | 15 | 85 | 10 | 30 | 30 | 5 | b-1 |
| Example 3 | 15 | 85 | 10 | 30 | 30 | 15 | b-1 |
| Example 4 | 15 | 85 | 10 | 30 | 30 | 30 | b-1 |
| Example 5 | 15 | 85 | 10 | 30 | 30 | 15 | b-2 |
| Example 6 | 15 | 85 | 10 | 30 | 30 | 15 | b-3 |
| Example 7 | 15 | 85 | 10 | 30 | 30 | 15 | b-4 |
| Example 8 | 15 | 85 | 10 | 30 | 30 | 15 | b-5 |
| Example 9 | 15 | 85 | 10 | 30 | 30 | 15 | b-6 |
| Example 10 | 15 | 85 | 10 | 30 | 30 | 15 | b-7 |
| Example 11 | 15 | 85 | 10 | 30 | 30 | 15 | b-8 |
| Example 12 | 15 | 85 | 3 | 30 | 30 | 15 | b-1 |
| Example 13 | 15 | 85 | 15 | 30 | 30 | 15 | b-1 |
| Example 14 | 15 | 85 | 20 | 30 | 30 | 15 | b-1 |
| Example 15 | 15 | 85 | 10 | 10 | 30 | 15 | b-1 |
| Example 16 | 15 | 85 | 10 | 20 | 30 | 15 | b-1 |
| Example 17 | 15 | 85 | 10 | 40 | 30 | 15 | b-1 |

TABLE 1-2

| | Components of resin composition in coating composition | | | | | | |
|---|---|---|---|---|---|---|---|
| | Solid content ratio by weight among components of coating composition | | | | | | species of |
| | | polyester | | | | | polyester resin |
| | acrylic-urethane | resin with | isocyanate | carbodiimide | oxazoline | melamine | with naphthalene |
| | copolymer resin | naphthalene | compound | compound | compound | compound | skeleton |
| | (a) | skeleton (b) | (c) | (d) | (e) | (f) | (b) |
| Example 18 | 15 | 85 | 10 | 30 | 10 | 15 | b-1 |
| Example 19 | 15 | 85 | 10 | 30 | 20 | 15 | b-1 |
| Example 20 | 15 | 85 | 10 | 30 | 40 | 15 | b-1 |
| Example 21 | 40 | 60 | 10 | 30 | 30 | 15 | b-1 |
| Example 22 | 30 | 70 | 10 | 30 | 30 | 15 | b-1 |
| Example 23 | 20 | 80 | 10 | 30 | 30 | 15 | b-1 |
| Example 24 | 5 | 95 | 10 | 30 | 30 | 15 | b-1 |
| Example 25 | 15 | 85 | 1 | 30 | 30 | 15 | b-1 |
| Example 26 | 15 | 85 | 25 | 30 | 30 | 15 | b-1 |
| Example 27 | 15 | 85 | 10 | 5 | 30 | 15 | b-1 |
| Example 28 | 15 | 85 | 10 | 45 | 30 | 15 | b-1 |
| Example 29 | 15 | 85 | 10 | 30 | 5 | 15 | b-1 |
| Example 30 | 15 | 85 | 10 | 30 | 45 | 15 | b-1 |
| Example 31 | 15 | 85 | 10 | 30 | 30 | 1 | b-1 |
| Example 32 | 15 | 85 | 10 | 30 | 30 | 35 | b-1 |
| Example 33 | 15 | 85 | 10 | 30 | 30 | 15 | b-9 |
| Example 34 | 15 | 85 | 10 | 30 | 30 | 15 | b-10 |

TABLE 1-3

| | Components of resin composition in coating composition | | | | | | | |
|---|---|---|---|---|---|---|---|---|
| | Solid content ratio by weight among components of coating composition | | | | | | | species of |
| | | polyester | polyester | | | | | polyester resin |
| | acrylic-urethane | resin with | resin without | isocyanate | carbodiimide | oxazoline | melamine | with naphthalene |
| | copolymer resin | naphthalene | naphthalene | compound | compound | compound | compound | skeleton |
| | (a) | skeleton (b) | skeleton | (c) | (d) | (e) | (f) | (b) |
| Comparative | — | 100 | — | 10 | 30 | 30 | — | b-1 |
| example 1 | | | | | | | | |
| Comparative | — | — | 100 | 10 | 30 | 30 | 15 | b-11 |
| example 2 | | | | | | | | |
| Comparative | 15 | — | 85 | 10 | 30 | 30 | 15 | b-12 |
| example 3 | | | | | | | | |
| Comparative | 15 | 85 | — | — | 30 | 30 | 15 | b-1 |
| example 4 | | | | | | | | |
| Comparative | 15 | 85 | — | 10 | — | 30 | 15 | b-1 |
| example 5 | | | | | | | | |
| Comparative | 15 | 85 | — | 10 | 30 | — | 15 | b-1 |
| example 6 | | | | | | | | |
| Comparative | 50 | 50 | — | 10 | 30 | 30 | 15 | b-1 |
| example 7 | | | | | | | | |
| Comparative | 60 | 40 | — | 10 | 30 | 30 | 15 | b-1 |
| example 8 | | | | | | | | |
| Comparative | 80 | 20 | — | 10 | 30 | 30 | 15 | b-1 |
| example 9 | | | | | | | | |
| Comparative | 90 | 10 | — | 10 | 30 | 30 | 15 | b-1 |
| example 10 | | | | | | | | |

TABLE 2-1

| | Characteristics of laminated polyester film | | | | | | | | | |
|---|---|---|---|---|---|---|---|---|---|---|
| | | | thick- | | boiling- | | | | | interfer- |
| | | | ness of | | resistant | adhesiveness to laminate | | | | ence |
| | disper- | reflec- | resin | | transpar- | | wet-heat- | boiling- | | fringe |
| | sion | tance | layer (X) | transpar- | ency | initial | resistant | resistant | UV-resistant | visibil- |
| | index | (%) | (nm) | ency | ΔHz (%) | adhesiveness | adhesiveness | adhesiveness | adhesiveness | ity |
| Example 1 | 1 | 5.2 | 95 | S 0.9 | A 2.6 | S 100 | S 100 | A 85 | A 85 | A |
| Example 2 | 1 | 5.3 | 95 | S 0.9 | S 1.4 | S 100 | S 100 | A 90 | A 90 | A |
| Example 3 | 2 | 5.5 | 95 | S 1.0 | S 1.2 | S 100 | S 100 | S 100 | S 100 | S |
| Example 4 | 3 | 5.6 | 95 | A 1.2 | A 2.5 | S 100 | S 100 | A 90 | A 90 | S |
| Example 5 | 4 | 5.5 | 95 | A 1.4 | A 2.7 | S 100 | S 100 | A 80 | A 80 | A |
| Example 6 | 1 | 5.5 | 95 | S 0.9 | S 1.2 | S 100 | S 100 | S 100 | S 100 | S |
| Example 7 | 1 | 5.5 | 95 | S 0.9 | S 1.2 | S 100 | S 100 | S 100 | S 100 | S |
| Example 8 | 5 | 5.3 | 95 | A 1.5 | A 2.7 | A 95 | A 95 | A 80 | A 80 | A |
| Example 9 | 5 | 5.3 | 95 | A 1.5 | A 2.7 | A 95 | A 95 | A 80 | A 80 | A |
| Example 10 | 2 | 5.5 | 95 | S 1.0 | S 1.2 | S 100 | S 100 | S 100 | S 100 | S |
| Example 11 | 2 | 5.5 | 95 | S 1.0 | S 1.2 | S 100 | S 100 | S 100 | S 100 | S |
| Example 12 | 2 | 5.5 | 95 | S 1.0 | A 2.6 | A 95 | A 90 | A 85 | A 85 | S |
| Example 13 | 2 | 5.5 | 95 | S 1.0 | S 1.2 | S 100 | S 100 | S 100 | S 100 | S |
| Example 14 | 2 | 5.5 | 95 | S 1.0 | S 1.2 | S 100 | S 100 | S 100 | S 100 | S |
| Example 15 | 2 | 5.5 | 95 | S 1.0 | A 2.7 | A 90 | A 85 | A 80 | A 80 | S |
| Example 16 | 2 | 5.5 | 95 | S 1.0 | A 2.5 | A 95 | A 90 | A 90 | A 90 | S |
| Example 17 | 2 | 5.5 | 95 | S 1.0 | S 1.2 | S 100 | S 100 | S 100 | S 100 | S |

TABLE 2-2

| Characteristics of laminated polyester film | | | |
|---|---|---|---|
| | thick- | boiling- | interfer- |

| | | | ness of | | resistant | adhesiveness to laminate | | | | ence |
|---|---|---|---|---|---|---|---|---|---|---|
| | disper- | reflec- | resin | trans- | transpar- | | wet-heat- | boiling- | | fringe |
| | sion | tance | layer (X) | par- | ency | initial | resistant | resistant | UV-resistant | visibil- |
| | index | (%) | (nm) | ency | ΔHz (%) | adhesiveness | adhesiveness | adhesiveness | adhesiveness | ity |
| Example 18 | 2 | 5.5 | 95 | S 1.0 | A 2.6 | A 95 | A 90 | A 85 | A 85 | S |
| Example 19 | 2 | 5.5 | 95 | S 1.0 | A 2.3 | A 95 | A 95 | A 95 | A 95 | S |
| Example 20 | 2 | 5.5 | 95 | S 1.0 | S 1.2 | S 100 | S 100 | S 100 | S 100 | S |
| Example 21 | 4 | 4.7 | 95 | A 1.4 | A 2.7 | S 100 | S 100 | A 80 | A 80 | A |
| Example 22 | 3 | 5.2 | 95 | A 1.3 | A 2.5 | S 100 | S 100 | A 90 | A 90 | S |
| Example 23 | 2 | 5.6 | 95 | S 1.0 | S 1.2 | S 100 | S 100 | S 100 | S 100 | S |
| Example 24 | 1 | 6.0 | 95 | S 0.9 | A 2.6 | A 90 | A 85 | A 85 | A 85 | A |
| Example 25 | 2 | 5.5 | 95 | S 1.0 | A 2.7 | A 90 | A 90 | A 80 | A 80 | S |
| Example 26 | 2 | 5.5 | 95 | A 1.2 | S 1.2 | S 100 | S 100 | S 100 | S 100 | S |
| Example 27 | 2 | 5.5 | 95 | S 1.0 | A 2.7 | A 80 | A 80 | A 80 | A 80 | S |
| Example 28 | 2 | 5.5 | 95 | A 1.2 | S 1.2 | S 100 | S 100 | S 100 | S 100 | S |
| Example 29 | 2 | 5.5 | 95 | S 1.0 | A 2.7 | A 80 | A 80 | A 80 | A 80 | S |
| Example 30 | 2 | 5.5 | 95 | A 1.2 | S 1.2 | S 100 | S 100 | S 100 | S 100 | S |
| Example 31 | 1 | 5.3 | 95 | S 0.9 | A 2.7 | S 100 | S 100 | A 80 | A 80 | A |
| Example 32 | 4 | 5.6 | 95 | A 1.2 | A 2.5 | S 100 | S 100 | A 90 | A 80 | S |
| Example 33 | 5 | 5.1 | 95 | A 1.5 | A 2.5 | S 100 | S 100 | A 90 | A 90 | A |
| Example 34 | 5 | 4.8 | 95 | A 1.5 | A 2.5 | S 100 | S 100 | A 90 | A 90 | A |

TABLE 2-3

| | Characteristics of laminated polyester film | | | | | | | | | |
|---|---|---|---|---|---|---|---|---|---|---|
| | | | thick- | | boiling- | | | | | interfer- |
| | | | ness of | | resistant | adhesiveness to laminate | | | | ence |
| | disper- | reflec- | resin | trans- | transpar- | | wet-heat- | boiling- | | fringe |
| | sion | tance | layer (X) | par- | ency | initial | resistant | resistant | UV-resistant | visibil- |
| | index | (%) | (nm) | ency | ΔHz (%) | adhesiveness | adhesiveness | adhesiveness | adhesiveness | ity |
| Comparative | 0 | 6.3 | 95 | S 0.8 | B 3.4 | A 95 | B 75 | B 70 | B 70 | C |
| example 1 | | | | | | | | | | |
| Comparative | 0 | 4.1 | 95 | S 0.8 | S 1.2 | S 100 | S 100 | S 100 | S 100 | C |
| example 2 | | | | | | | | | | |
| Comparative | 1 | 4.1 | 95 | S 0.8 | S 1.2 | S 100 | S 100 | S 100 | S 100 | C |
| example 3 | | | | | | | | | | |
| Comparative | 1 | 5.5 | 95 | S 0.8 | B 3.4 | A 90 | B 75 | B 70 | B 70 | A |
| example 4 | | | | | | | | | | |
| Comparative | 1 | 5.5 | 95 | S 0.8 | B 3.8 | A 80 | B 55 | B 50 | B 50 | A |
| example 5 | | | | | | | | | | |
| Comparative | 1 | 5.5 | 95 | S 0.8 | B 3.4 | A 90 | B 75 | B 70 | B 70 | A |
| example 6 | | | | | | | | | | |
| Comparative | 7 | 4.5 | 95 | A 1.6 | A 2.7 | S 100 | S 100 | A 80 | A 80 | B |
| example 7 | | | | | | | | | | |
| Comparative | 10 | 4.4 | 95 | B 2.1 | B 3.4 | S 100 | S 100 | B 70 | B 70 | B |
| example 8 | | | | | | | | | | |
| Comparative | 15 | 4.3 | 95 | B 2.5 | B 3.6 | S 100 | S 100 | B 60 | B 60 | C |
| example 9 | | | | | | | | | | |
| Comparative | 20 | 4.2 | 95 | C 3.0 | B 3.8 | S 100 | S 100 | B 50 | B 50 | C |
| example 10 | | | | | | | | | | |

In Table 1-1 to Table 1-3, the solid content ratio by weight in a coating composition is based on the total solid content, which represents 100, of the acrylic-urethane copolymer resin (a) and the polyester resin (b) with a naphthalene skeleton. It should be noted, however, that in Comparative examples 2 and 3, the ratio is based on the solid content, which represents 100, of the acrylic-urethane copolymer resin (a) and the polyester resin free of a naphthalene skeleton.

### INDUSTRIAL APPLICABILITY

The present invention relates to laminated polyester film having a resin layer that is high not only in initial adhesiveness, but also high particularly in wet-heat-resistant adhesiveness, boiling-resistant adhesiveness, adhesiveness after UV irradiation, boiling-resistant adhesiveness, and ability to depress the deterioration in transparency (reduced transparency) caused by immersion in boiling water (i.e., high in boiling-resistant transparency), as well as high in ability to depress the formation of an iris-like pattern (interference pattern) likely to occur after lamination with a hard coat layer (i.e., high in visibility), and can be applicable to a highly adhesive film for optical use of various displays, a highly adhesive film for a hard-coat film for industrial uses of windows of automobiles and buildings or building materials, and a highly adhesive film which is superior in adhesiveness to various laminated materials such as an ink.

### EXPLANATION OF NUMERALS

1. resin layer (X)
2. polyester film
3. X-direction
4. Y-direction
5. Z-direction

1. A laminated polyester film comprising a polyester film and a resin layer (X) provided on at least one side thereof,
the resin layer (X) being a layer formed from a coating composition containing acrylic-urethane copolymer resin (a) and polyester resin with a naphthalene skeleton (b), and
the film undergoing a change in the film haze, 4 Hz, of less than 3.0% during boiling test (ΔHz=film haze after boiling test−film haze before boiling test).

2. A laminated polyester film comprising a polyester film and a resin layer (X) provided on at least one side thereof,
the resin layer (X) being a layer formed from a coating composition containing acrylic-urethane copolymer resin (a), polyester resin with a naphthalene skeleton (b), an isocyanate compound (c), a carbodiimide compound (d), and an oxazoline compound (e), and
the aggregates that contain the acrylic-urethane copolymer resin (a) in the layer (X) having a dispersion index of 5 or less.

3. A laminated polyester film as described in claim 1, wherein the minimum value of the spectral reflectance of the resin layer (X) in the wavelength range of 450 nm or more and 650 nm or less is 4.5% or more and 6.0% or less.

4. A laminated polyester film as described in claim 1, wherein the polyester resin (b) is copolymer polyester resin in which the aromatic dicarboxylic acid component containing a metal sulfonate group accounts for 1 to 30 mol % of the total quantity of the dicarboxylic acid components of the polyester.

5. A laminated polyester film as described in claim 1, wherein the polyester resin (b) contains a diol component as expressed by Formula (1) given below: 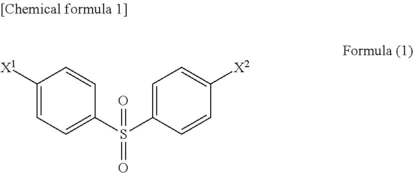
wherein, X¹ and X² are —(CₙH₂ₙO)ₘ—H; n is an integer of 2 or more and 4 or less; and m is an integer of 1 or more and 15 or less.

6. A laminated polyester film as described in claim 1, wherein the ratio by weight between the solid content of the acrylic-urethane copolymer resin (a) and the solid content of the polyester resin (b) in the coating composition is 40/60 to 5/95.

7. A laminated polyester film as described in claim 1, wherein the coating composition contains 3 to 20 parts (as solid content) by weight of the isocyanate compound (c), 10 to 40 parts by weight (as solid content) by weight of the carbodiimide compound (d), and 10 to 40 parts by weight (as solid content) by weight of the oxazoline compound (e) relative to the total solid content by weight, i.e. 100 parts by weight, of the acrylic-urethane copolymer resin (a) and the polyester resin (b).

8. A laminated polyester film as described in claim 7, wherein the coating composition further contains 5 to 30 parts (as solid content) by weight of a melamine compound (f).

9. A laminated polyester film as described in claim 2, wherein the minimum value of the spectral reflectance of the resin layer (X) in the wavelength range of 450 nm or more and 650 nm or less is 4.5% or more and 6.0% or less.

10. A laminated polyester film as described in claim 2, wherein the polyester resin (b) is copolymer polyester resin in which the aromatic dicarboxylic acid component containing a metal sulfonate group accounts for 1 to 30 mol % of the total quantity of the dicarboxylic acid components of the polyester.

11. A laminated polyester film as described in claim 3, wherein the polyester resin (b) is copolymer polyester resin in which the aromatic dicarboxylic acid component containing a metal sulfonate group accounts for 1 to 30 mol % of the total quantity of the dicarboxylic acid components of the polyester.

12. A laminated polyester film as described in claim 2, wherein the polyester resin (b) contains a diol component as expressed by Formula (1) given below: 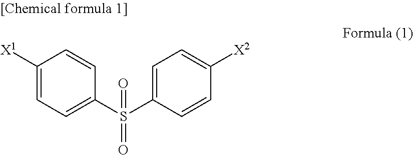
wherein, X¹ and X² are —(CₙH₂ₙO)ₘ—H; n is an integer of 2 or more and 4 or less; and m is an integer of 1 or more and 15 or less.

13. A laminated polyester film as described in claim 3, wherein the polyester resin (b) contains a diol component as expressed by Formula (1) given below: 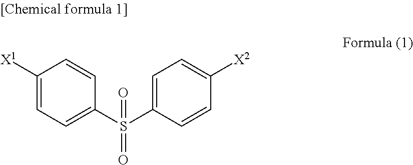
wherein, X¹ and X² are —(CₙH₂ₙO)ₘ—H; n is an integer of 2 or more and 4 or less; and m is an integer of 1 or more and 15 or less.

14. A laminated polyester film as described in claim 4, wherein the polyester resin (b) contains a diol component as expressed by Formula (1) given below: 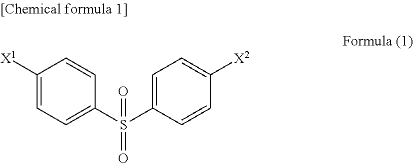
wherein, X¹ and X² are —(CₙH₂ₙO)ₘ—H; n is an integer of 2 or more and 4 or less; and m is an integer of 1 or more and 15 or less.

15. A laminated polyester film as described in claim 2, wherein the ratio by weight between the solid content of the acrylic-urethane copolymer resin (a) and the solid content of the polyester resin (b) in the coating composition is 40/60 to 5/95.

16. A laminated polyester film as described in claim 3, wherein the ratio by weight between the solid content of the acrylic-urethane copolymer resin (a) and the solid content of the polyester resin (b) in the coating composition is 40/60 to 5/95.

17. A laminated polyester film as described in claim 4, wherein the ratio by weight between the solid content of the acrylic-urethane copolymer resin (a) and the solid content of the polyester resin (b) in the coating composition is 40/60 to 5/95.

18. A laminated polyester film as described in claim 5, wherein the ratio by weight between the solid content of the acrylic-urethane copolymer resin (a) and the solid content of the polyester resin (b) in the coating composition is 40/60 to 5/95.

19. A laminated polyester film as described in claim 2, wherein the coating composition contains 3 to 20 parts (as solid content) by weight of the isocyanate compound (c), 10 to 40 parts by weight (as solid content) by weight of the carbodiimide compound (d), and 10 to 40 parts by weight (as solid content) by weight of the oxazoline compound (e) relative to the total solid content by weight, i.e. 100 parts by weight, of the acrylic-urethane copolymer resin (a) and the polyester resin (b).

20. A laminated polyester film as described in claim 3, wherein the coating composition contains 3 to 20 parts (as solid content) by weight of the isocyanate compound (c), 10 to 40 parts by weight (as solid content) by weight of the carbodiimide compound (d), and 10 to 40 parts by weight (as solid content) by weight of the oxazoline compound (e) relative to the total solid content by weight, i.e. 100 parts by weight, of the acrylic-urethane copolymer resin (a) and the polyester resin (b).
